(19) United States
(12) Patent Application Publication
(10) Pub. No.: US 2019/0307141 A1
(43) Pub. Date: Oct. 10, 2019

(54) LACTIC ACID BACTERIAL FERMENTATION PROMOTING AGENT

(71) Applicant: MEIJI CO., LTD., Tokyo (JP)

(72) Inventors: Keisuke FURUICHI, Odawara-shi, Kanagawa (JP); Emi TOYAMA, Odawara-shi, Kanagawa (JP)

(73) Assignee: MEIJI CO., LTD., Tokyo (JP)

(21) Appl. No.: 16/309,565

(22) PCT Filed: Jun. 16, 2017
(86) PCT No.: PCT/JP2017/022286

§ 371 Date: Dec. 13, 2018

(30) Foreign Application Priority Data
Jun. 16, 2016 (JP) 2016-120225

(51) Int. Cl. A23C 9/13; A23C 9/123

(52) U.S. Cl. CPC A23C 9/1307; A23C 9/123; A23Y 2220/15; A23Y 2260/00; A23Y 2220/29; A23V 2002/00; A23Y 2240/41; A23Y 2240/75

(57) ABSTRACT

The present invention provides a lactic acid bacterial fermentation-promoting agent and a fermentation method suitable for use in food production. The present invention relates to a fermentation promoting agent for a lactic acid bacterium, having a compound having a purine skeleton with a hydrogen atom attached to the carbon atom at position 2, and a method for promoting fermentation for a lactic acid bacterium using the same and a method for producing a fermented food such as fermented milk.

### TECHNICAL FIELD

The present invention relates to a fermentation promoting agent for a lactic acid bacterium.

### BACKGROUND ART

Lactic acid bacteria have been used for the production of fermentation products including various foods. Promoted growth and fermentation of lactic acid bacteria provide significant industrial benefits in view of the streamlining of growth and fermentation process of lactic acid bacteria. On the other hand, palatability is also an extremely important factor for foods including yogurt, and thus a fermentation promoting agent which has an adverse effect on the taste is not desirable. Given the use for food production, it is also important that the fermentation promoting agent can be produced inexpensively and that it exhibits a fermentation promoting effect even in a small amount. It would be useful to exhibit the effect when used in a small amount, because the existing production equipment can be used without reinforcement of equipment such as a facility for adding a fermentation promoting agent.

As technologies for promoting the growth and fermentation of lactic acid bacteria, there are a lactic acid bacterial growth-promoting agent containing, as an active ingredient, acidic buttermilk containing dead cells of lactic acid bacteria (Patent Literature 1); a lactic acid bacterial growth-promoting agent comprising agar having a reducing sugar content and a weight average molecular weight adjusted in certain ranges (Patent Literature 2); and a method for promoting the growth of gram-positive bacteria such as lactic acid bacteria using an extract derived from Musa species (Patent Literature 3). However, there is still a need for the development of a lactic acid bacterial fermentation promoting agent that shows an effect even when used in a small amount, can be prepared inexpensively and has little influence on the taste.

Patent Literature 4 discloses that when inosine 5′-phosphate is added to a frozen culture of Lactobacillus bacteria or Lactobacillus delbrueckii subsp. bulgaricus, a protecting effect on freezing damages is obtained.

Patent Literature 5 discloses a combination of “two free nucleobases, one ribonucleoside and two deoxynucleosides”, particularly a combination of guanine, thymine, cytidine, 2′-deoxyadenosine, and 2′-deoxyuridine, as a minimum combination of DNA precursors which needs to be added to a synthetic medium for the growth of lactic acid bacteria belonging to the genus Lactobacillus or the genus Bifidobacterium.

Patent Literature 6 discloses that a bacterial cell suspension of a Lactobacillus bacterium to which 1.25 mM each of inosine and guanosine was added, was cultured, and the degradation rates of inosine and guanosine were measured, and thus a Lactobacillus bacterium having a high purine degrading ability was identified.

However, none of Patent Literatures 4 to 6 teach or suggest a lactic acid bacterial fermentation-promoting agent.

### CITATION LIST

### Patent Literature

### Patent Literature 1: International Publication WO2008/001497

### Patent Literature 2: JP Patent Publication No. 2014-094001 A

### Patent Literature 3: International Publication WO2007/052081

### Patent Literature 4: International Publication WO2005/003327

### Patent Literature 5: JP Patent Publication No. 2000-279166 A

### Patent Literature 6: International Publication WO2009/069704

### SUMMARY OF INVENTION

### Technical Problem

The problem underlying the present invention is to provide a lactic acid bacterial fermentation promoting agent, that is suitable for use in food production.

### Solution to Problem

The present inventors conducted intensive studies to solve the above-mentioned problem, and have found that a compound having a purine skeleton with a hydrogen atom attached to the carbon atom at position 2 can effectively promote lactic acid bacterial fermentation, whereby the present invention was accomplished.

More specifically, the present invention encompasses the followings.

[1] A fermentation promoting agent for a lactic acid bacterium, comprising a compound having a purine skeleton with a hydrogen atom attached to the carbon atom at position 2.
[2] The fermentation promoting agent according to [1], wherein said compound is a purine base which is adenine or hypoxanthine, a purine nucleoside or purine nucleotide comprising the base as a constituent, or a salt thereof.
[3] The fermentation promoting agent according to [1] or [2], wherein said compound is selected from the group consisting of adenine, hypoxanthine, adenosine, inosine, deoxyadenosine, deoxyinosine, adenylic acid, and inosinic acid, and salts thereof.
[4] The fermentation promoting agent according to any of [1] to [3], wherein the lactic acid bacterium is a Streptococcus bacterium.
[5] The fermentation promoting agent according to [4], wherein the Streptococcus bacterium is Streptococcus thermophilus.
[6] The fermentation promoting agent according to any of [1] to [3], wherein the lactic acid bacterium is a Lactobacillus bacterium.
[7] The fermentation promoting agent according to [6], wherein the Lactobacillus bacterium is Lactobacillus delbrueckii, Lactobacillus helveticus, Lactobacillus acidophilus, Lactobacillus johnsonii, Lactobacillus casei, Lactobacillus fermentum, or Lactobacillus gasseri.
[8] The fermentation promoting agent according to any of [1] to [3], wherein the lactic acid bacterium is a Lactococcus bacterium.
[9] The fermentation promoting agent according to [8], wherein the Lactococcus bacterium is Lactococcus lactis.
[10] The fermentation promoting agent according to any of [1] to [3], wherein the lactic acid bacterium is a Leuconostoc bacterium.
[11] The fermentation promoting agent according to [10], wherein the Leuconostoc bacterium is Leuconostoc lactis.
[12] The fermentation promoting agent according to any of [1] to [11], for use in fermenting a fermentation substrate comprising milk or a milk-derived product.
[13] A method for promoting lactic acid bacterial fermentation, comprising adding a compound having a purine skeleton with a hydrogen atom attached to the carbon atom at position 2 to a fermentation substrate, and culturing lactic acid bacteria in/on the fermentation substrate to ferment the fermentation substrate.
[14] The method according to [13], wherein said compound is a purine base which is adenine or hypoxanthine, a purine nucleoside or purine nucleotide comprising the base as a constituent, or a salt thereof.
[15] The method according to [13] or [14], wherein said compound is selected from the group consisting of adenine, hypoxanthine, adenosine, inosine, deoxyadenosine, deoxyinosine, adenylic acid, and inosinic acid, and salts thereof.
[16] The method according to any of [13] to [15], wherein the lactic acid bacteria comprise at least one selected from the group consisting of a Streptococcus bacterium, a Lactobacillus bacterium, a Lactococcus bacterium, and a Leuconostoc bacterium.
[17] The method according to [16], wherein the Streptococcus bacterium is Streptococcus thermophilus.
[18] The method according to [16] or [17], wherein the Lactobacillus bacterium is at least one selected from the group consisting of Lactobacillus delbrueckii, Lactobacillus helveticus, Lactobacillus acidophilus, Lactobacillus johnsonii, Lactobacillus casei, Lactobacillus fermentum, and Lactobacillus gasseri.
[19] The method according to any of [16] to [18], wherein the Lactococcus bacterium is Lactococcus lactis.
[20] The method according to any of [16] to [19], wherein the Leuconostoc bacterium is Leuconostoc lactis.
[21] The method according to any of [13] to [18], wherein Streptococcus thermophilus and Lactobacillus delbrueckii subsp. bulgaricus are mixed-cultured.
[22] The method according to any of [13] to [21], wherein said compound is added to a fermentation substrate in an amount of 0.0001 to 10 wt %.
[23] A method for producing a fermented food, comprising fermenting a fermentation substrate by the method according to any of [13] to [22].
[24] The method according to [23], wherein the fermentation substrate comprises milk or a milk-derived product, and the fermented food is a milk-fermented food.
[25] The method according to [24], wherein the milk-fermented food is fermented milk.

The disclosure of JP Patent Application No. 2016-120225, to which the present application claims the priority, are incorporated into the present specification.

### Advantageous Effects of Invention

According to the present invention, the fermentation of a lactic acid bacterium can be promoted even with a small amount of fermentation promoting agent added.

### BRIEF DESCRIPTION OF DRAWINGS

FIG. 1 shows the results of testing the fermentation promoting effect on S. thermophilus of sodium inosinate. Solid square, 0.0001%; solid triangle, 0.0002%; solid diamond, 0.0004%; x, 0.001%; open square, 0.002%; and open circle, control. The unit H of the fermentation time on the horizontal axis denotes time [hour(s)] (the same applies to the following figures).

FIG. 2 shows the fermentation promoting effect on S. thermophilus of a 1:1 mixture of sodium inosinate and sodium guanylate. Solid square, 0.0001%; solid triangle, 0.0002%; solid diamond, 0.0005%; x, 0.0010%; and open circle, control.

FIG. 3 shows the results of testing the fermentation promoting effect on S. thermophilus of sodium inosinate at a higher concentration. Solid square, 0.1%; solid triangle, 0.5%; solid diamond, 1%; and open circle, control.

FIG. 4 shows the fermentation promoting effect on S. thermophilus of a 1:1 mixture of sodium inosinate and sodium guanylate at a higher concentration. Solid square, 0.1%; solid triangle, 1%; and open circle, control.

FIG. 5 shows the results of testing the fermentation promoting effect on S. thermophilus of adenine and derivatives thereof. Solid square, adenine; solid triangle, adenosine; solid diamond, deoxyadenosine (d-adenosine); solid circle, AMP; and open circle, control.

FIG. 6 shows the results of testing the fermentation promoting effect on S. thermophilus of hypoxanthine and derivatives thereof. Solid square, hypoxanthine; solid triangle, inosine; solid diamond, deoxyinosine (d-inosine); solid circle, IMP; and open circle, control.

FIG. 7 shows the results of testing the fermentation promoting effect on S. thermophilus of guanine and derivatives thereof. Solid square, guanine; solid triangle, guanosine; solid diamond, deoxyguanosine (d-guanosine); and open circle, control.

FIG. 8 shows the results of testing the fermentation promoting effect on S. thermophilus of xanthine and uric acid. Solid square, xanthine; solid triangle, uric acid; and open circle, control.

FIG. 9 shows the results of testing the fermentation promoting effect on S. thermophilus of pyrimidine bases and derivatives thereof. Solid square, cytosine; open square, cytidine; solid triangle, uracil; open triangle, uridine; solid diamond, thymine; open diamond, thymidine; and open circle, control.

FIG. 10 shows the fermentation promoting effect of inosinic acid on S. thermophiles OLS3059 strain.

FIG. 11 shows the fermentation promoting effect of inosinic acid on S. thermophiles OLS3294 strain.

FIG. 12 shows the fermentation promoting effect of inosinic acid on S. thermophiles OLS3289 strain.

FIG. 13 shows the fermentation promoting effect of inosinic acid on S. thermophiles OLS3469 strain.

FIG. 14 shows the fermentation promoting effect of inosinic acid on S. thermophiles OLS3058 strain.

FIG. 15 shows the fermentation promoting effect of inosinic acid on S. thermophiles OLS3290 strain.

FIG. 16 shows the fermentation promoting effect, with an acidity as the indicator, of sodium inosinate and a 1:1 mixture of sodium inosinate and sodium guanylate in the mixed fermentation of S. thermophilus and L. bulgaricus (Starter A). Solid square, sodium inosinate; solid triangle, 1:1 mixture of sodium inosinate and sodium guanylate; and open circle, control.

FIG. 17 shows the fermentation promoting effect, with an acidity as the indicator, of sodium inosinate and a 1:1 mixture of sodium inosinate and sodium guanylate in the mixed fermentation of S. thermophilus and L. bulgaricus (Starter B). Solid square, sodium inosinate; solid triangle, 1:1 mixture of sodium inosinate and sodium guanylate; and open circle, control.

FIG. 18 shows the fermentation promoting effect, with an L-lactic acid concentration as the indicator, of sodium inosinate and a 1:1 mixture of sodium inosinate and sodium guanylate in the mixed fermentation of S. thermophilus and L. bulgaricus (Starter A). Solid square, sodium inosinate; solid triangle, 1:1 mixture of sodium inosinate and sodium guanylate; and open circle, control.

FIG. 19 shows the fermentation promoting effect, with an L-lactic acid concentration as the indicator, of sodium inosinate and a 1:1 mixture of sodium inosinate and sodium guanylate in the mixed fermentation of S. thermophilus and L. bulgaricus (Starter B). Solid square, sodium inosinate; solid triangle, 1:1 mixture of sodium inosinate and sodium guanylate; and open circle, control.

FIG. 20 shows fermentation levels, with an acidity as the indicator, in the fermentation system comprising sodium inosinate using a frozen mixture starter of S. thermophilus OLS3059 strain and L. bulgaricus OLL1073R-1 strain. Open diamond, sodium inosinate being added to the fermentation broth base; solid diamond, sodium inosinate being added during starter freezing.

FIG. 21 shows fermentation levels, with an acidity as an indicator, in the fermentation system comprising a 1:1 mixture of sodium inosinate and sodium guanylate using a frozen mixture starter of S. thermophilus OLS3059 strain and L. bulgaricus OLL1073R-1 strain. Open diamond, 1:1 mixture of sodium inosinate and sodium guanylate (“1:1 mixture”) being added to the fermentation broth base; solid diamond, 1:1 mixture of sodium inosinate and sodium guanylate being added during starter freezing.

FIG. 22 shows fermentation levels, with an acidity as the indicator, in the fermentation system comprising sodium inosinate using a frozen mixture starter of S. thermophilus OLS3294 strain and L. bulgaricus OLL1255 strain. Open diamond, sodium inosinate being added to a fermentation broth base; and solid diamond, sodium inosinate being added during starter freezing.

FIG. 23 shows fermentation levels, with an acidity as the indicator, in the fermentation system comprising a 1:1 mixture of sodium inosinate and sodium guanylate using a frozen mixture starter of S. thermophilus OLS3294 strain and L. bulgaricus OLL1255 strain. Open diamond, 1:1 mixture of sodium inosinate and sodium guanylate (“1:1 mixture”) being added to a fermentation broth base; and solid diamond, 1:1 mixture of sodium inosinate and sodium guanylate being added during starter freezing.

FIG. 24 shows the results of testing the fermentation promoting effect on S. thermophilus of mixtures of adenosine and guanosine with different mixing ratios. Open circle, control; open diamond, 10:0; solid circle, 7:3; solid square, 5:5; and solid diamond, 3:7.

FIG. 25 shows the results of testing the fermentation promoting effect on S. thermophilus of mixtures of inosine and guanosine with different mixing ratios. Open circle, control; open diamond, 10:0; solid circle, 7:3; solid square, 5:5; and solid diamond, 4:6.

FIG. 26 shows the fermentation promoting effect of sodium inosinate on various lactic acid bacteria. A) Lactobacillus delbrueckii subsp. bulgaricus OLL1073R-1 strain. B) Lactobacillus delbrueckii subsp. lactis OLL2693 strain.

FIG. 27 shows the fermentation promoting effect of sodium inosinate on various lactic acid bacteria. A) Lactobacillus gasseri OLL2716 strain. B) Lactobacillus helveticus OLL1482 strain.

FIG. 28 shows the fermentation promoting effect of sodium inosinate on various lactic acid bacteria. A) Lactococcus lactis subsp. lactis OLS3445 strain. B) Leuconostoc lactis OLS5167 strain.

FIG. 29 shows the fermentation promoting effect of sodium inosinate on various lactic acid bacteria. A) Lactobacillus acidophilus OLL1836 strain. B) Lactobacillus johnsonii OLL2725 strain.

FIG. 30 shows the fermentation promoting effect of sodium inosinate on various lactic acid bacteria. A) Lactobacillus casei OLL2230 strain. B) Lactobacillus fermentum OLL2690 strain.

FIG. 31 shows the fermentation promoting effect of sodium inosinate on various lactic acid bacteria. A) Lactococcus lactis subsp. diacetylactis OLS3021 strain. B) Lactococcus lactis subsp. cremoris OLS3313 strain.

FIG. 32 shows the fermentation promoting effect of sodium inosinate on Lactobacillus delbrueckii strains. A) Lactobacillus delbrueckii subsp. bulgaricus OLL1181 strain. B) Lactobacillus delbrueckii subsp. bulgaricus OLL1255 strain. Solid square, sodium inosinate (0.002%); solid triangle, 1:1 mixture of sodium inosinate and sodium guanylate (0.025%); and open circle, control.

FIG. 33 shows the fermentation promoting effect of sodium inosinate on Lactobacillus delbrueckii strains. A) Lactobacillus delbrueckii subsp. lactis OLL2708 strain. B) Lactobacillus delbrueckii subsp. delbrueckii OLL203471 strain. Solid square, sodium inosinate (0.002%); solid triangle, 1:1 mixture of sodium inosinate and sodium guanylate (0.025%); and open circle, control.

FIG. 34 shows the fermentation promoting effect of sodium inosinate on Lactobacillus delbrueckii subsp. indicus OLL203412 strain. Solid square, sodium inosinate (0.002%); solid triangle, 1:1 mixture of sodium inosinate and sodium guanylate (0.025%); and open circle, control.

FIG. 35 shows the fermentation promoting effect of sodium inosinate and a 1:1 mixture of sodium inosinate and sodium guanylate on bacterial strains of the Lactobacillus species. A) Lactobacillus acidophilus OLL1846 strain. B) Lactobacillus johnsonii OLL203276 strain. Solid square, sodium inosinate (0.002%); solid triangle, 1:1 mixture of sodium inosinate and sodium guanylate (0.025%); and open circle, control.

FIG. 36 shows the fermentation promoting effect of adenylic acid and a 1:1 mixture of sodium inosinate and sodium guanylate on bacterial strains of the Lactobacillus species. A) Lactobacillus delbrueckii subsp. bulgaricus OLL1073R-1 strain. B) Lactobacillus gasseri OLL2716. Solid square, AMP (0.05 mmol/kg); solid triangle, 1:1 mixture of sodium inosinate and sodium guanylate (0.025%); and open circle, control.

FIG. 37 shows the fermentation promoting effect of adenylic acid and a 1:1 mixture of sodium inosinate and sodium guanylate on bacterial strains of the Lactobacillus species. A) Lactobacillus acidophilus OLL1836 strain. B) Lactobacillus johnsonii OLL2725 strain. Solid square, AMP (0.05 mmol/kg); solid triangle, 1:1 mixture sodium inosinate and sodium guanylate (0.025%); and open circle, control.

FIG. 38 shows the fermentation promoting effect of adenylic acid and a 1:1 mixture of sodium inosinate and sodium guanylate on Lactobacillus helveticus OLL1482 strain. Solid square, AMP (0.05 mmol/kg); solid triangle, 1:1 mixture of sodium inosinate and sodium guanylate (0.025%); and open circle, control.

FIG. 39 shows the fermentation promoting effects of adenylic acid and a 1:1 mixture of sodium inosinate and sodium guanylate on various lactic acid bacterial strains. A) Lactococcus lactis subsp. lactis OLS3445 strain. B) Leuconostoc lactis OLS5167 strain. Solid square, AMP (0.05 mmol/kg); solid triangle, 1:1 mixture of sodium inosinate and sodium guanylate (0.025%); and open circle, control.

### DESCRIPTION OF EMBODIMENTS

Hereinafter, the present invention will be described in detail.

The present invention is based on the present inventors' finding that a compound having a purine skeleton with a hydrogen atom attached to the carbon atom at position 2 has an action to promote lactic acid bacterial fermentation. The present invention relates to a fermentation promoting agent for a lactic acid bacterium comprising a compound having a purine skeleton with a hydrogen atom attached to the carbon atom at position 2.

The “compound having a purine skeleton” refers to a substance having as a basic skeleton the following structure (purine skeleton):

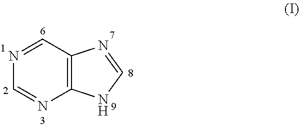

wherein the numbers in Formula I represent the numbers of positions of carbon atoms or nitrogen atoms. Generally, compounds having a purine skeleton is collectively called purines. Examples of the compound having a purine skeleton typically include purine bases, purine nucleosides, purine nucleotides, and salts thereof.

The compound having a purine skeleton used as an active ingredient of the fermentation promoting agent of the present invention has a purine skeleton with a hydrogen atom attached to the carbon atom at position 2 (in the above Formula I, the carbon atom represented by the number 2). Examples of such compound include adenine and hypoxanthine (purine bases), purine nucleosides comprising adenine or hypoxanthine as a constituent, purine nucleotides comprising adenine or hypoxanthine as a constituent, and salts thereof.

Purine nucleoside is a substance consisting of a purine base attached to a sugar (ribose or deoxyribose), and may be a ribonucleoside or a deoxyribonucleoside. Examples of the purine nucleoside comprising adenine or hypoxanthine as a constituent include adenosine and inosine (ribonucleoside), and deoxyadenosine and deoxyinosine (deoxyribonucleoside).

Purine nucleotide is a substance consisting of a purine nucleoside attached to one or more phosphate groups, and may be a ribonucleotide or a deoxyribonucleotide. The purine nucleotide may be nucleoside 1-phosphate (nucleoside monophosphate), nucleoside diphosphate, or nucleoside triphosphate. Examples of the purine nucleotide comprising adenine or hypoxanthine as a constituent include adenylic acid (adenosine 1-phosphate or adenosine monophosphate; AMP), adenosine diphosphate (ADP), adenosine triphosphate (ATP), deoxyadenosine monophosphate (dAMP), deoxyadenosine diphosphate (dADP), deoxyadenosine triphosphate (dATP), inosinic acid (inosine 1-phosphate or inosine monophosphate; IMP), inosine diphosphate (IDP), inosine triphosphate (ITP), deoxyinosine monophosphate (dIMP), deoxyinosine diphosphate (dIDP), and deoxyinosine triphosphate (dITP).

The compound having a purine skeleton with a hydrogen atom attached to the carbon atom at position 2 according to the present invention, also includes derivatives of purine bases, purine nucleosides, and purine nucleotides. The “derivative” as used herein refers to a compound in which a purine base moiety, a sugar residue moiety, and/or a phosphate group moiety of a purine base, purine nucleoside or purine nucleotide is chemically modified or has a substituent introduced.

The compound having a purine skeleton with a hydrogen atom attached to the carbon atom at position 2 according to the present invention may be a salt, for example, a salt of adenine, hypoxanthine, or a purine nucleoside or purine nucleotide comprising as a constituent adenine or hypoxanthine. In the present invention, the particularly preferred salts are alkali metal salts (for example, sodium salts and potassium salts), and the alkali metal salts include, but are not limited to, sodium adenylate and sodium inosinate.

In one embodiment, the compound having a purine skeleton with a hydrogen atom attached to the carbon atom at position 2 may be selected from the group consisting of adenine, hypoxanthine, adenosine, inosine, deoxyadenosine, deoxyinosine, adenylic acid, inosinic acid, and salts thereof.

The fermentation promoting agent of the present invention may comprise at least one, preferably 1 to 4, for examples, 1 to 3, or 1 to 2 of the compounds having a purine skeleton with a hydrogen atom attached to the carbon atom at position 2.

In one embodiment, the fermentation promoting agent of the present invention does not comprises a compound having a pyrimidine skeleton (for example, thymine, cytosine, uracil and 5′-methylcytosine, and nucleotides and nucleotides comprising these as a constituent; excluding compounds having a purine skeleton). The fermentation promoting agent of the present invention may or may not comprise a compound having a purine skeleton with an amino group or an oxygen atom attached to the carbon atom at position 2 (for example, guanine, guanosine, deoxyguanosine, guanylic acid, xanthine, or uric acid, or salts thereof). When the fermentation promoting agent of the present invention comprises the compound having a purine skeleton with a hydrogen atom attached to the carbon atom at position 2 and the compound having a purine skeleton with an amino group attached to the carbon atom at position 2, the amount (g) of the compound having a purine skeleton with a hydrogen atom attached to the carbon atom at position 2 is 30 wt % or more, preferably 40 wt % or more, more preferably 50 wt % or more, and preferably less than 100 wt %, relative to the total weight (g) of the compound and the compound having a purine skeleton with an amino group attached to the carbon atom at position 2. For example, the compound having a purine skeleton with a hydrogen atom attached to the carbon atom at position 2 and the compound having a purine skeleton with an amino group is attached to the carbon atom at position 2 can be added to a fermentation substrate in a mixing ratio (weight ratio) of 1:1.5 to 1.5:1.

In one embodiment, the fermentation promoting agent of the present invention may comprise the compound having a purine skeleton with a hydrogen atom attached to the carbon atom at position 2 (for example, any compound selected from the group consisting of adenine, hypoxanthine, adenosine, inosine, deoxyadenosine, deoxyinosine, adenylic acid, and inosinic acid, or salts thereof) and guanylic acid or a salt thereof. Examples of the salt include, but are not limited to, alkali metal salts (for example, sodium salts and potassium salts). The fermentation promoting agent of the present invention may comprise, for example, both sodium inosinate and sodium guanylate (for example, at a blending ratio of 1:1).

The fermentation promoting agent of the present invention may comprise, as the active ingredient, only the compound having a purine skeleton with a hydrogen atom attached to the carbon atom at position 2. One example of the fermentation promoting agent of the present invention may comprise only sodium inosinate as the active ingredient. Further, another example of the fermentation promoting agent of the present invention may comprise only a mixture of sodium inosinate and sodium guanylate (for example, a 1:1 mixture) as the active ingredient. Another example of the fermentation promoting agent of the present invention may comprise only adenylic acid as the active ingredient.

The fermentation promoting agent of the present invention does not need to comprise a combination of two nucleobases, one ribonucleoside, and two deoxynucleosides, for example, a combination of guanine, thymine, cytidine, 2′-deoxyadenosine, and 2′-deoxyuridine. In a preferred embodiment, the fermentation promoting agent of the present invention does not comprise such combination.

The compound having a purine skeleton with a hydrogen atom attached to the carbon atom at position 2 or the fermentation promoting agent of the present invention is capable of promoting the fermentation of a lactic acid bacterium.

The lactic acid bacterium is cultured in/on a fermentation substrate supplemented with the compound or the fermentation promoting agent of the present invention to ferment the fermentation substrate, and an indicator of progress of the fermentation is examined over time. As a result, if it is shown that the fermentation has proceeded faster than in a control (that is a group without the compound having a purine skeleton with a hydrogen atom attached to the carbon atom at position 2 or the fermentation promoting agent of the present invention), the compound or the fermentation promoting agent can be verified to have a fermentation promoting effect. As the indicator of progress of fermentation, for example, an increase in the amount of lactic acid produced by the lactic acid bacterial fermentation, or an increase in the acidity or a decrease in pH value of a fermented product associated with an increase in the amount of lactic acid, can be used, but the indicator is not limited thereto. If the value of the indicator of progress of fermentation is improved as compared with the control, the difference in the value of the indicator from the control enlarges with time during fermentation (preferably for at least 2 hours), and then an improved value of the indicator is still shown as compared with the control for a certain period of time (for example, for at least 1 hour or more), the compound or the fermentation promoting agent can be determined to have a fermentation promoting effect on the lactic acid bacterium. The acidity (weight percent concentration of lactic acid) of a fermentation product can be determined, for example, by gradually adding dropwise phenolphthalein to the fermentation product, determining the amount of 0.1N NaOH (=0.1 mol/L NaOH) required to turn pale red (about pH 8.5), and calculating the acidity therefrom in a conventional manner. Further, an L-lactic acid concentration can be measured, for example, with high performance liquid chromatography (HPLC) at the temperature of 40° C. using a mobile phase of 2 mM CuSO₄ (II).5H₂O and 5% 2-propanol. For the specific test procedures, the descriptions of Examples below can be referred to.

The compound having a purine skeleton with a hydrogen atom attached to the carbon atom at position 2 and the fermentation promoting agent of the present invention do not need to have a cryoprotecting effect on the lactic acid bacteria including Streptococcus bacteria and Lactobacillus bacteria, for example, Streptococcus thermophilus and Lactobacillus delbrueckii subsp. bulgaricus, and may not have the cryoprotecting effect on the lactic acid bacteria.

The present invention also relates to a compound having a purine skeleton with a hydrogen atom attached to the carbon atom at position 2 used in the present invention for promoting lactic acid bacterial fermentation.

The fermentation promoting agent for the lactic acid bacterium of the present invention may further comprise other ingredients, typically an auxiliary substance used in the field of production of foods or food additives, such as a carrier, an excipient, or a preservative. The fermentation promoting agent for the lactic acid bacterium may be in any form such as a liquid, a powder, a granule, a gel, a solid, or an encapsulated form. The dissolution in a solvent, powderization, granulation, gelling, solidification, encapsulation and the like can be carried out in accordance with known formulation techniques.

The compound having a purine skeleton with a hydrogen atom attached to the carbon atom at position 2 or the fermentation promoting agent of the present invention used in the present invention can be used for fermenting any fermentation substrate that is available for fermentation by a lactic acid bacterium. For example, the compound having a purine skeleton with a hydrogen atom attached to the carbon atom at position 2 or the fermentation promoting agent of the present invention comprising the compound may be those for use in fermenting a fermentation substrate comprising milk or a milk-derived product.

The present invention provides a method for promoting lactic acid bacterial fermentation using the above-mentioned compound having a purine skeleton with a hydrogen atom attached to the carbon atom at position 2 or the fermentation promoting agent of the present invention. More specifically, the present invention provides a method for promoting lactic acid bacterial fermentation, comprising adding the compound or the fermentation promoting agent of the present invention to a fermentation substrate and culturing the lactic acid bacteria in/on the fermentation substrate to ferment the fermentation substrate. The present invention also relates to a fermentation method using lactic acid bacteria, comprising adding the compound or the fermentation promoting agent of the present invention to a fermentation substrate and culturing the lactic acid bacteria in/on the fermentation substrate to ferment the fermentation substrate. The present invention also relates to a method for producing a lactic acid bacterial product, comprising adding the compound or the fermentation promoting agent of the present invention to a fermentation substrate, culturing the lactic acid bacteria in/on the fermentation substrate, and collecting a lactic acid bacterial product produced by the lactic acid bacteria. In these methods, the lactic acid bacteria may be inoculated into the fermentation substrate before adding the compound having a purine skeleton with a hydrogen atom attached to the carbon atom at position 2 or the fermentation promoting agent of the present invention to the fermentation substrate, or at the same time as or after adding the compound or the fermentation promoting agent to the fermentation substrate.

The term “fermentation substrate” as used herein means a substrate compound (such as a carbohydrate) or a substrate material that is available for fermentation by lactic acid bacteria. Examples of the fermentation substrate include, but are not limited to, milk, a milk-derived product, a saccharified cereal, soymilk, a soybean extract, a fruit, a vegetable, a fruit juice, a vegetable juice, a fruit or vegetable extract, and a fermentation broth base (for example, a yogurt base) containing at least one thereof. The term “milk” as used herein includes raw milk, raw milk after composition adjustment (composition standardization), fat-reduced or non-fat milk (such as skim milk); a powdered milk such as a powdered skim milk and whole milk powder; a reconstituted skim milk, a diluted milk, a concentrated milk, and other processed milks. The “milk” may be subjected to a pretreatment used in food production such as homogenization, sterilization/cooling, and/or filtration. In the context of the present invention, the “milk” may be any non-human mammal milk (animal milk) such as cow milk, goat milk, buffalo milk, horse milk, camel milk, or sheep milk. The “milk-derived product” may or may not contain lactose, but preferably contains lactose. Examples of the “milk-derived product” include a curd (coagulated milk), a cream, buttermilk, a buttermilk powder, whey, milk protein (such as casein or whey protein) and a hydrolysate thereof (such as casein-hydrolyzed peptide). The fermentation substrates may be used alone or in combination of two or more in the present invention.

In the methods of the present invention, at least one, preferably 1 to 4, for example, 1 to 3 or 1 to 2 of the compounds having a purine skeleton with a hydrogen atom attached to the carbon atom at position 2 may be added to the fermentation substrate.

The compound having a purine skeleton with a hydrogen atom attached to the carbon atom at position 2 or the fermentation promoting agent of the present invention can be added in an amount such that the compound having a purine skeleton with a hydrogen atom attached to the carbon atom at position 2 is added at typically 0.0001 wt % or more and 20 wt % or less, preferably 0.0001 to 10 wt %, more preferably 0.0001 to 1 wt %, and for example 0.0005 to 0.1 wt % of the compound (gram) relative to the total weight (gram) of the fermentation substrate(s), but is not limited to these amounts. Such addition amount means a total amount when 2 or more of the compounds are used. Herein, the unit wt % (weight percent) of the compound relative to the total weight can be denoted by % (wt/wt), wt/wt (%), or w/w %. The compound or the fermentation promoting agent of the present invention can promote the fermentation of a lactic acid bacterium by adding it in a very small amount. This means not only that the production cost of a fermented food can be reduced but also that the influence on the taste of the fermented food, such as unpleasant tastes, can be markedly reduced or prevented.

In one embodiment of the method of the present invention, the compounds having a pyrimidine skeleton (for example, thymine, cytosine, uracil and 5′-methylcytosine, and nucleosides and nucleotides comprising these as a constituent; excluding compounds having a purine skeleton) is not added to the fermentation substrate. In one embodiment of the present invention, the above-mentioned compound having a purine skeleton with an amino group or an oxygen atom attached to the carbon atom at position 2 may or may not be added to the fermentation substrate, in addition to the compound having a purine skeleton with a hydrogen atom attached to the carbon atom at position 2. Preferably, in the method of the present invention, when both of the compound having a purine skeleton with a hydrogen atom attached to the carbon atom at position 2 and the compound having a purine skeleton with an amino group attached to the carbon atom at position 2 are added to the fermentation substrate, the addition amount of the compound having a purine skeleton with a hydrogen atom attached to the carbon atom at position 2 is 30 wt % or more, preferably 40 wt % or more, more preferably 50 wt % or more, and preferably less than 100 wt % of such compound (gram) relative to the total weight (gram) of such compound and the compound having a purine skeleton with an amino group attached to the carbon atom at position 2. For example, the compound having a purine skeleton with a hydrogen atom attached to the carbon atom at position 2 and the compound having a purine skeleton with an amino group attached to the carbon atom at position 2 may be added to the fermentation substrate in a mixing ratio (weight ratio) of 1:1.5 to 1.5:1.

In one embodiment of the method of the present invention, the compound having a purine skeleton with a hydrogen atom attached to the carbon atom at position 2 (for example, any compound selected from the group consisting of adenine, hypoxanthine, adenosine, inosine, deoxyadenosine, deoxyinosine, adenylic acid, and inosinic acid, or salts thereof) or the fermentation promoting agent comprising the compound, and guanylic acid or a salt thereof, may be added to the fermentation substrate.

In the method of the present invention, a combination of two nucleobases, one ribonucleoside, and two deoxynucleosides does not need to be added to the fermentation substrate, and particularly the combination of guanine, thymine, cytidine, 2′-deoxyadenosine, and 2′-deoxyuridine is not added to the fermentation substrate.

In one embodiment of the method of the present invention, sodium inosinate, or a mixture (for example, a 1:1 mixture) of sodium inosinate and sodium guanylate may be added to the fermentation substrate.

The above-mentioned compound having a purine skeleton with an amino group or an oxygen atom attached to the carbon atom at position 2 or the fermentation promoting agent of the present invention can promote fermentation by various lactic acid bacteria. The lactic acid bacterium to be used for the fermentation in the present invention may be from animals or from plants.

Preferred examples of the lactic acid bacterium include Streptococcus bacteria. Preferred examples of the Streptococcus bacteria include, but are not limited to, the Streptococcus species such as Streptococcus thermophilus (or S. thermophilus). Examples of the Streptococcus thermophilus strains include, but are not limited to, S. thermophilus OLS3059 strain (accession number FERM BP-10740), S. thermophilus OLS3294 strain (accession number NITE P-77), S. thermophilus OLS3289 strain (ATCC 19258), S. thermophilus OLS3469 strain (IFO 13957/NBRC 13957), S. thermophilus OLS3058 strain, and S. thermophilus OLS3290 strain (accession number FERM BP-19638).

S. thermophilus OLS3059 strain is internationally deposited under the Budapest Treaty with International Patent Organism Depositary, National Institute of Technology and Evaluation (NITE-IPOD) (#120, 2-5-8, Kazusakamatari, Kisarazu-shi, Chiba, Japan) on Feb. 29, 1996 (the date of the original deposit) under the accession number FERM BP-10740. This deposited strain was transferred from the domestic deposit (the original deposit) to the international deposit under the Budapest Treaty on Nov. 29, 2006.

S. thermophilus OLS3294 strain is deposited with Patent Microorganisms Depositary, National Institute of Technology and Evaluation (NPMD) (#122, 2-5-8, Kazusakamatari, Kisarazu-shi, Chiba, Japan) on Feb. 10, 2005 (the date of deposit) under the accession number NITE P-77.

Further, S. thermophilus OLS3290 strain is internationally deposited under the Budapest Treaty with International Patent Organism Depositary, National Institute of Technology and Evaluation (NITE-IPOD) (#120, 2-5-8, Kazusakamatari, Kisarazu-shi, Chiba, Japan) on Jan. 19, 2004 (the date of the original deposit) under the accession number FERM BP-19638. This deposited strain was transferred from the domestic deposit (the original deposit) to the international deposit under the Budapest Treaty based on the transfer request of Sep. 6, 2013.

S. thermophilus OLS3289 strain is the same as the bacterium that is available under ATCC® Catalog No. 19258 from the American Type Culture Collection (ATCC).

S. thermophilus OLS3469 strain is the same as the bacterium that is available under NBRC No. 13957 from Biological Resource Center, Biotechnology Center, National Institute of Technology and Evaluation (NBRC) (2-5-8, Kazusakamatari, Kisarazu-shi, Chiba, Japan).

Note that Meiji Co., Ltd. is not only the depositor of S. thermophilus OLS3290 strain, but is also the current depositor of S. thermophilus OLS3059 strain and S. thermophilus OLS3294 strain.

Further examples of the preferred lactic acid bacterium include, but are not limited to, a Lactobacillus bacterium, a Lactococcus bacterium, and a Leuconostoc bacterium. Examples of the Lactobacillus bacterium include, but are not limited to, Lactobacillus species such as Lactobacillus delbrueckii, Lactobacillus helveticus, Lactobacillus acidophilus, Lactobacillus johnsonii, Lactobacillus casei, Lactobacillus fermentum, and Lactobacillus gasseri. Examples of Lactobacillus delbrueckii include, but are not limited to, Lactobacillus delbrueckii subsp. bulgaricus (also called Lactobacillus bulgaricus), Lactobacillus delbrueckii subsp. lactis, Lactobacillus delbrueckii subsp. delbrueckii, and Lactobacillus delbrueckii subsp. indicus. Examples of Lactococcus lactis include, but are not limited to, Lactococcus lactis subsp. lactis, Lactococcus lactis subsp. diacetylactis, and Lactococcus lactis subsp. cremoris. Examples of the Lactococcus species include, but are not limited to, Lactococcus species such as Lactococcus lactis. Examples of the Leuconostoc bacterium include, but are not limited to, Leuconostoc species such as Leuconostoc lactis. Examples of the Lactobacillus bacterium, Lactococcus bacterium, or Leuconostoc bacterium include, but are not limited to, Lactobacillus delbrueckii subsp. bulgaricus OLL1073R-1 strain, Lactobacillus delbrueckii subsp. lactis OLL2693 strain, Lactobacillus delbrueckii subsp. bulgaricus OLL1181 strain, Lactobacillus delbrueckii subsp. bulgaricus OLL1255 strain, Lactobacillus delbrueckii subsp. lactis OLL2708 strain, Lactobacillus delbrueckii subsp. delbrueckii OLL203471 strain, Lactobacillus delbrueckii subsp. indicus OLL203412 strain, Lactobacillus helveticus OLL1482 strain, Lactobacillus acidophilus OLL1836 strain, Lactobacillus acidophilus OLL1846 strain, Lactobacillus johnsonii OLL2725 strain, Lactobacillus casei OLL2230 strain, Lactobacillus fermentum OLL2690 strain, Lactobacillus gasseri OLL2716 strain, Lactobacillus johnsonii OLL203276 strain, Lactococcus lactis subsp. lactis OLS3445 strain, Lactococcus lactis subsp. diacetylactis OLS3021 strain, Lactococcus lactis subsp. cremoris OLS3313 strain, and Leuconostoc lactis OLS5167 strain.

The strains shown in Table 1 below are internationally deposited under the Budapest Treaty with International Patent Organism Depositary, National Institute of Technology and Evaluation (NITE-IPOD) (#120, 2-5-8, Kazusakamatari, Kisarazu-shi, Chiba, Japan) or Patent Microorganisms Depositary, National Institute of Technology and Evaluation (NPMD) (#122, 2-5-8, Kazusakamatari, Kisarazu-shi, Chiba, Japan).

TABLE 1
Deposited strains

| | | | |
|---|---|---|---|
| | | | Date of transfer to |
| Accession | | Depositary | international |
| number | Date of deposit | institution | deposit |

Lactobacillus delbrueckii subsp. bulgaricus OLL1073R-1

| | | | |
|---|---|---|---|
| FERM | Feb. 22, 1999 | NITE-IPOD | Nov. 29, 2006 |
| BP-10741 | (Date of original deposit) | | |

Lactobacillus gasseri OLL2716

| | | | |
|---|---|---|---|
| FERM | May 24, 1999 | NITE-IPOD | Jan. 14, 2000 |
| BP-6999 | (Date of original deposit) | | |

Lactobacillus delbrueckii subsp. bulgaricus OLL1181

| | | | |
|---|---|---|---|
| FERM | Jul. 16, 2010 | NITE-IPOD | — |
| BP-11269 | | | |

Lactobacillus delbrueckii subsp. bulgaricus OLL1255

| | | | |
|---|---|---|---|
| NITE | Feb. 10, 2005 | NPMD | Apr. 1, 2009 |
| BP-76 | (Date of original deposit) | | |

Note that the current depositor of Lactobacillus bulgaricus OLL1073R-1 strain, Lactobacillus gasseri OLL2716 strain, Lactobacillus bulgaricus OLL1181 strain, and Lactobacillus bulgaricus OLL1255 strain is Meiji Co., Ltd.

Further, Lactobacillus delbrueckii subsp. lactis OLL2693 strain, Lactobacillus helveticus OLL1482 strain, Leuconostoc lactis OLS5167 strain, Lactobacillus acidophilus OLL1836 strain, Lactobacillus johnsonii OLL2725 strain, Lactobacillus casei OLL2230 strain, Lactobacillus fermentum OLL2690 strain, Lactobacillus delbrueckii subsp. lactis OLL2708 strain, Lactobacillus delbrueckii subsp. delbrueckii OLL203471 strain, Lactobacillus delbrueckii subsp. indicus OLL203412 strain, Lactobacillus acidophilus OLL1846 strain, and Lactobacillus johnsonii OLL203276 strain are respectively the same as the bacteria that are available under JCM Catalog Nos: JCM1148, JCM1120T, JCM6123T, JCM1132T, JCM2012T, JCM1124T, JCM1120T, JCM1557, JCM20075, JCM15610T, JCM1023, and JCM1022T from Riken BioResource Research Center (RIKEN BRC), Japan Collection of Microorganisms (RIKEN BRC-JCM, Japan).

The fermentation (culture) conditions for the lactic acid bacterium can be set according to a conventional method. For example, fermentation can usually be carried out at 35 to 50° C., for example 40 to 45° C. The fermentation time varies depending on the fermentation substrate and fermentation conditions, but it can be set to, for example, about 2 to 24 hours. If necessary, the pH of the fermentation substrate may be appropriately adjusted (for example, adjusted to around pH 6.5) before fermentation.

The lactic acid bacterium can be prepared according to a conventional method. The lactic acid bacterium may be inoculated in any amount that can be used for fermentation by the lactic acid bacterium. For example, the inoculation amount of the lactic acid bacterium can be set in the range of 0.01 to % (v/w %) expressed as a ratio of inoculation amount (ml) to the total weight (g) of the fermentation substrate. The % ratio of the volume to the total weight (v/w %) may be also denoted as % (vol/wt) or vol/wt (%). Since the above-mentioned compound or the fermentation promoting agent of the present invention can markedly promote lactic acid bacterial fermentation, the inoculation amount of the lactic acid bacterium can be reduced, for example, to approximately 1/10 to ⅔ of the typical inoculation amount (the number of bacterial cells to be inoculated).

In the method of the present invention, lactic acid bacteria of at least one bacterial strain are used. As the lactic acid bacterium, the above-mentioned lactic acid bacteria, for example, lactic acid bacteria comprising at least one selected from the group consisting of a Streptococcus bacterium, a Lactobacillus bacterium, a Lactococcus bacterium, and a Leuconostoc bacterium, can be used in the method.

In the method of the present invention, it is also preferred to mixed-culture (co-culture) 2 or more species of lactic acid bacteria and/or 2 or more bacterial strains of lactic acid bacteria. For example, in the method of the present invention, it is also preferred to mixed-culture Streptococcus thermophilus and Lactobacillus delbrueckii subsp. bulgaricus. The compound having a purine skeleton with a hydrogen atom attached to the carbon atom at position 2 or the fermentation promoting agent of the present invention can also promote lactic acid bacteria fermentation even in the mixed-culture of the lactic acid bacteria, for example, in the mixed-culture of Streptococcus thermophilus and Lactobacillus delbrueckii subsp. bulgaricus. In a preferred embodiment, the mixed-culture of lactic acid bacteria, for example, the mixed-culture of Streptococcus thermophilus and Lactobacillus delbrueckii subsp. bulgaricus, is carried out by using a fermentation substrate comprising milk or a milk-derived product.

Yogurt is produced using various lactic acid bacteria and/or yeasts worldwide, but in the typical yogurt production, mixed-culture (mixed fermentation) of Streptococcus thermophilus and Lactobacillus delbrueckii subsp. bulgaricus is carried out. Streptococcus thermophilus is also often used in the production of fermented foods including various cheeses such as mozzarella cheese. Lactic acid bacteria of the Lactobacillus species, the Lactococcus species, and the Leuconostoc species are used in the production of fermented foods such as fermented milk (yogurt), cheese, fermented cream, fermented butter, bread, fermented vegetables, lactic acid bacteria fermented product-containing beverages, and alcoholic beverages. The method for promoting lactic acid bacterial fermentation is also very useful for producing a fermented food more efficiently. The present invention also provides a method for producing a fermented food comprising fermenting a fermentation substrate by the method for promoting lactic acid bacterial fermentation of the present invention. A lactic acid bacterium, for example, Streptococcus thermophilus, is generally used as a starter in the production of a fermented food. The fermentation substrate used for a fermented food is preferably edible itself (for example, for human or non-human mammals such as domesticated animals). The fermentation substrate may be used alone or in combination of two or more in the method for producing a fermented food.

In a preferred embodiment, the present invention relates to a method for producing a milk-fermented food, comprising fermenting a fermentation substrate comprising milk or a milk-derived product by the method for promoting lactic acid bacterial fermentation according to the present invention. The fermentation substrate comprising milk or a milk-derived product may be milk or a milk-derived product itself. The definitions of milk and milk-derived product are as described above. The fermentation substrate comprising milk or a milk-derived product may be milk or a milk-derived product supplemented with another substrate compound (such as carbohydrate) or a substrate material, or another ingredient. Examples of the fermented food (milk-fermented food) produced by this method include, but are not limited to, fermented milk, lactic acid bacteria fermented product-containing beverage, cheese, fermented cream, and fermented butter. The term “fermented milk” as used herein refers to milk fermented using a lactic acid bacterium, or a combination of a lactic acid bacterium and another fermentation microorganism (typically, yeast). Examples of the fermented milk include yogurt. Examples of the cheese include mozzarella cheese, Camembert cheese, quark cheese, Gouda cheese, and cheddar cheese. In this method for producing a milk-fermented food, the fermentation substrate may be used alone or in combination of two or more thereof. For example, fermentation substrates containing two or more types of milk, e.g., raw milk and a powdered skim milk, may be used. Alternatively, milk and a milk-derived product may be used in combination as a fermentation substrate, and for example, raw milk, a powdered skim milk and whey protein may be used in combination. Further, a fermentation substrate comprising milk or a milk-derived product and a fermentation substrate not comprising any milk or milk-derived product may be used in combination. A fermentation broth base wherein a required amount of water and/or another ingredient such as a sweetener are added to and mixed with such fermentation substrate, can also be used as a fermentation substrate.

The method for producing a fermented food (for example, milk-fermented food) according to the present invention can be carried out essentially by the same method as the conventional method for producing a fermented food, except that the compound having a purine skeleton with a hydrogen atom attached to the carbon atom at position 2 or the fermentation promoting agent of the present invention is added in an appropriate amount to a fermentation system to promote fermentation of a lactic acid bacterium. After completing the fermentation to achieve appropriate conditions for respective fermented foods, the resulting fermented products may be e.g., processed and filled in containers to produce fermented foods. For example, fermented milk can be produced by inoculating lactic acid bacterium into milk, to which the above compound or the fermentation promoting agent of the present invention is added according to the above-mentioned fermentation promotion method, and fermenting the milk. Typical yogurt can be produced by inoculating Streptococcus thermophilus and a Lactobacillus bacterium (typically Lactobacillus delbrueckii subsp. bulgaricus) into milk, to which the compound or the fermentation promoting agent of the present invention is added according to the above-mentioned fermentation promoting method, and fermenting the milk in a mixed-culture thereof. However, procedures for producing fermented milk, including yogurt, are not limited thereto.

In the method for producing a fermented food according to the present invention, a lactic acid bacterium which is known to be used for producing a fermented food (for example, a milk-fermented food) can be preferably used.

Other material(s) in addition to the fermentation substrate may be added at an appropriate stage in the production of a fermented food (for example, a milk-fermented food). Examples of other materials include, but are not limited to, food additives such as a sweetener (sucrose, stevia, sucralose, or the like), an acidifier, a preservative, a flavor, a thickener, and calcium lactate; agar, gelatin, fruit juice, fruit pulp, fruit sauce, cream, aloe mesophyll, and jam. It is usually preferred not to add a yeast extract known as a bifidobacteria growth-promoting agent, in order to avoid increased unpleasant tastes.

The production of fermented milk such as yogurt may be carried out by either a pre-fermentation type method or a post-fermentation type method. In the pre-fermentation type method, milk is inoculated with lactic acid bacteria (starter), and after completion of the fermentation, the resulting fermented milk is filled into a container. Homogenization, addition of other materials such as fruit pulp, freezing or the like may be carried out before filling into the container. In the post-fermentation type method, the fermentation is carried out after filling milk, lactic acid bacteria and other materials into a container. A mixed-culture of multiple types of lactic acid bacteria used for production of fermented milk, for example, a mixed-culture of Streptococcus thermophilus and a Lactobacillus bacterium such as Lactobacillus delbrueckii subsp. bulgaricus, can usually be carried out usually at 35 to 50° C., for example, 40° C. to 45° C. In the production of fermented milk, the fermentation is usually carried out until the acidity reaches 0.7 to 0.8%, followed by cooling to 10° C. or less to stop the fermentation, but the production method is not limited to. The fermentation time can be, for example, 1 to 24 hours, more generally approximately 3 to 7 hours.

Cheese can be typically produced by inoculating lactic acid bacteria used for the production of cheese, for example, lactic acid bacteria comprising Streptococcus thermophilus as a starter into milk, to which the above compound or the fermentation promoting agent of the present invention is added according to the above-mentioned fermentation promoting method, and fermenting the milk, then adding rennet (milk-curdling enzymes) to curdle the milk; separating a curdled product (curd) from whey; and, shaping, sterilizing and/or fermenting⋅and aging it or the like. However, procedures for producing cheese are not limited thereto.

The fermentation time can be reduced by the method of the present invention as compared with the method without the compound having a purine skeleton with a hydrogen atom attached to the carbon atom at position 2 or the fermentation promoting agent of the present invention, since the present method can significantly promote lactic acid bacterial fermentation. For example, when fermented milk such as yogurt is produced according to the present method, the fermentation time can be preferably reduced by 1 to 4 hours as compared with the method without the compound or the fermentation promoting agent of the present invention, but the time reduction is not limited thereto because it varies depending on fermentation conditions or the like. According to the present method, the fermentation process in the production of a milk-fermented food can be completed early, making the production of milk-fermented foods more efficient.

When using such method of the present invention, it is possible to produce a milk-fermented food which is comparable to or more excellent in tastes (sourness and sweetness, and the presence or absence of bitterness and harsh taste, and the like) and physical properties (such as smoothness and firmness), as compared with fermented foods (for example, milk-fermented foods) produced in the same manner except that the above-mentioned compound or the fermentation promoting agent of the present invention is not added.

### EXAMPLES

Hereinafter, the present invention is further specifically described by reference to Examples. However, the technical scope of the present invention is not limited to these Examples.

### [Example 1] Evaluation of Fermentation Promoting Effect of Sodium Inosinate, and a Mixture of Sodium Inosinate and Sodium Guanylate

In this Example, two test substances, sodium inosinate, and a 1:1 mixture of sodium inosinate and sodium guanylate, were examined for the fermentation promoting effect on Streptococcus thermophilus (or S. thermophilus).

The above test substances were each added to UHT sterilized milk (cow milk sterilized by a UHT method (ultrahigh temperature sterilization method); sterilized at 130° C. for 2 seconds), and warmed to 43° C. Sodium inosinate was added at 0.0001%, 0.0002%, 0.0004%, 0.001%, or 0.002% (each also denoted as % (wt/wt)) and the 1:1 mixture of sodium inosinate and sodium guanylate was added at 0.0001%, 0.0002%, 0.0005%, or 0.001% (each also denoted as % (wt/wt)) to the UHT sterilized milk. To the warmed UHT sterilized milk, Streptococcus thermophilus OLS3059 strain (accession number FERM BP-10740) was inoculated as a starter in an inoculation amount of 1% (vol/wt) (corresponding to a bacterial cell concentration of 1 to 2×10⁷ cfu/mL), and the fermentation was started at 43° C. As a control, the fermentation using UHT sterilized milk without the above test substances was also carried out. Herein, S. thermophilus OLS3059 strain was cultured using MRS (Difco) at 37° C. for 16 hours for preparation of the bacterial cells to be used in the fermentation below. After culturing using MRS, the bacterial cells were collected by centrifugation (8,000 g for 5 minutes), and then suspended into 0.8% sodium chloride solution. The resulting bacterial cell suspension (bacterial cell concentration of 1 to 2×10⁹ cfu/mL) was used as a starter. In the following Examples using S. thermophilus, a S. thermophilus bacterial suspension prepared according to the same method as the present Example was used as a starter, unless otherwise stated.

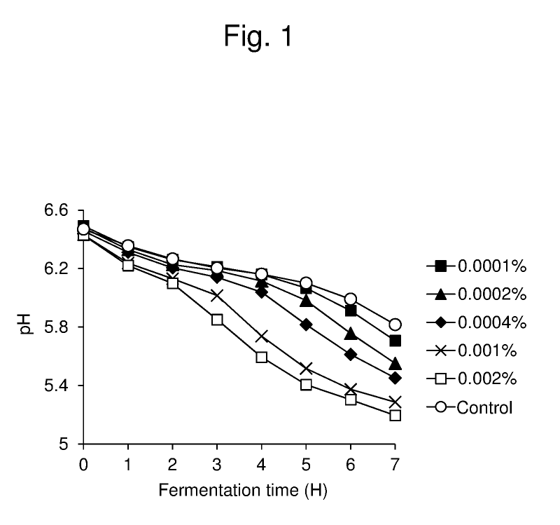

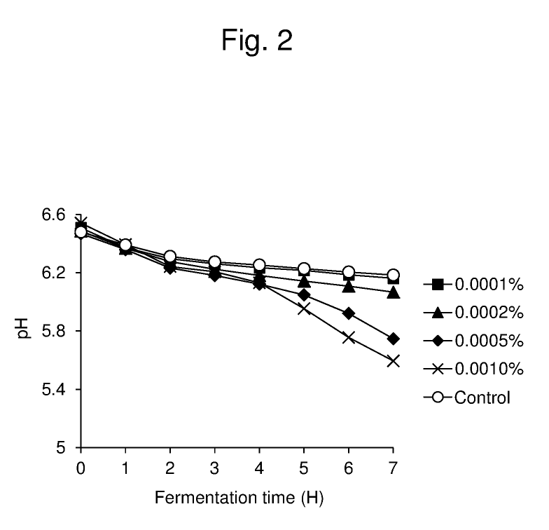

The pH of the fermentation liquid was measured over time. A decrease in the pH in the lactic acid bacteria culture medium and the fermentation liquid indicates an increase in the amount of lactic acid production associated with the lactic acid bacterial fermentation and is used as an indicator of the progress degree of the lactic acid bacterial fermentation. The measurement results are shown in FIG. 1 and FIG. 2.

Sodium inosinate exhibited a decrease in the pH, as compared with the control, even in an addition rate of 0.0001% (wt/wt), which shows the fermentation promoting effect. Further, as the addition rate increased, the fermentation promoting effect of sodium inosinate increased (FIG. 1). The 1:1 mixture of sodium inosinate and sodium guanylate exhibited the fermentation promoting effect at an addition rate of 0.0002% (wt/wt) or more in this test, and as the addition rate increased, the fermentation promoting effect also increased (FIG. 2).

These results indicated that inosinic acid and a 1:1 mixture of inosinic acid and guanylic acid have a fermentation promoting effect on S. thermophilus.

Subsequently, the fermentation promoting effects of higher concentrations of these test samples were examined. Sodium inosinate was added at 0.1%, 0.5%, or 1% (wt/wt) and the 1:1 mixture of sodium inosinate and sodium guanylate was added at 0.1% or 1% (wt/wt) to the UHT sterilized milk. As a result, since the pH of the UHT sterilized milk increased, pH of the UHT sterilized milk was adjusted to around 6.5 with lactic acid, and then the fermentation was carried out by the same method as above.

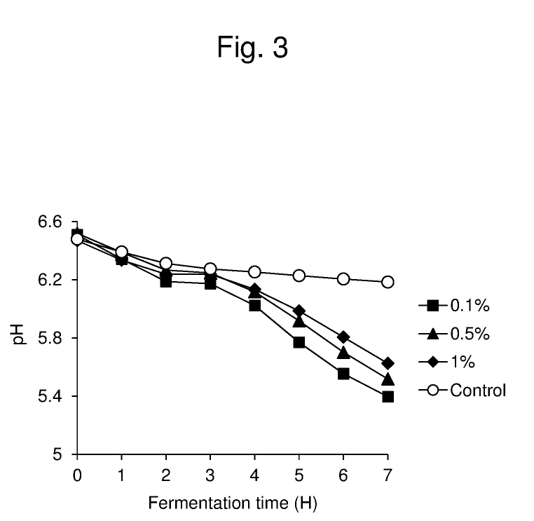

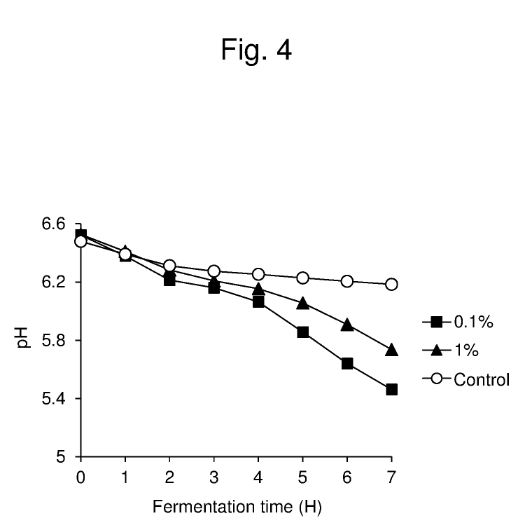

The pH of the fermentation liquid was measured over time. As a result, both sodium inosinate and the 1:1 mixture of sodium inosinate and sodium guanylate also exhibited evident fermentation promoting effects at higher addition rates of 0.1 to 1% (wt/wt) (FIG. 3 and FIG. 4).

### [Example 2] Evaluation of Fermentation Promoting Effect of Purine Bases, Pyrimidine Bases, and Derivatives Thereof

As the fermentation promoting effects of inosinic acid and the 1:1 mixture of inosinic acid and guanylic acid on S. thermophilus were demonstrated in Example 1, other purines were also examined for the fermentation promoting effect on S. thermophilus.

In this test, a 10 mM solution of each of the test substances (purines) in 0.1N NaOH was added to UHT sterilized milk in an amount such that the concentration of the test substance in the UHT sterilized milk was 0.05 mmol/kg, whereby UHT sterilized milk supplemented with the test substance was prepared. Additionally, as a control, the fermentation using UHT sterilized milk without the test substances (purines) was also carried out.

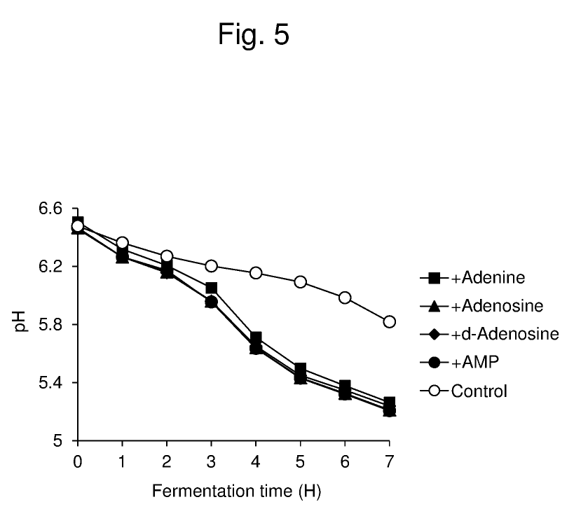

UHT sterilized milk supplemented with adenine which is a purine base, or a derivative thereof that is adenosine, deoxyadenosine, or adenylic acid (adenosine monophosphate; AMP) added as a test substance, was warmed to 43° C., subsequently S. thermophilus OLS3059 strain was inoculated as a starter in an amount of 1% (vol/wt), and the fermentation was started at 43° C. The pH of the fermentation liquid was measured over time. The measurement results are shown in FIG. 5. As a result, adenine, adenosine, deoxyadenosine, and AMP all exhibited notable fermentation promoting effects (FIG. 5).

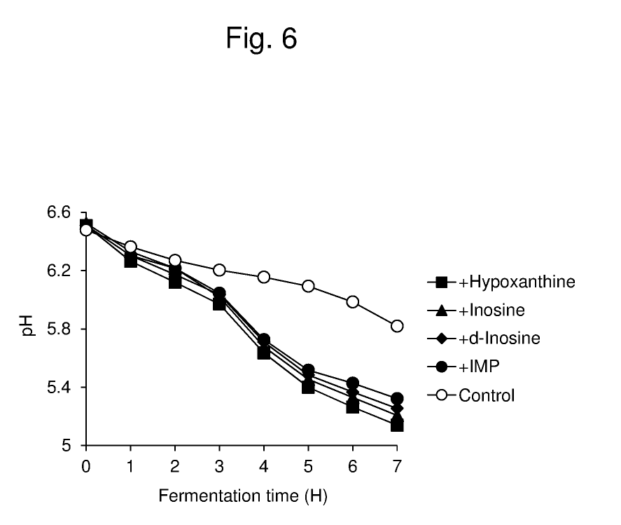

Subsequently, the fermentation promoting effects of hypoxanthine which is a purine base, and derivatives thereof that are inosine, deoxyinosine, and inosinic acid (inosine monophosphate; IMP) were tested by the same method as the above test using adenine and the like, using them as test substances. As a result of the measurement, as shown in FIG. 6, hypoxanthine, inosine, deoxyinosine, and IMP all exhibited notable fermentation promoting effects (FIG. 6).

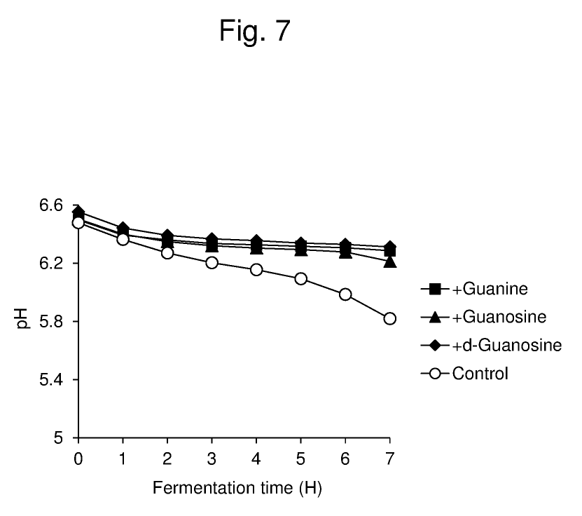

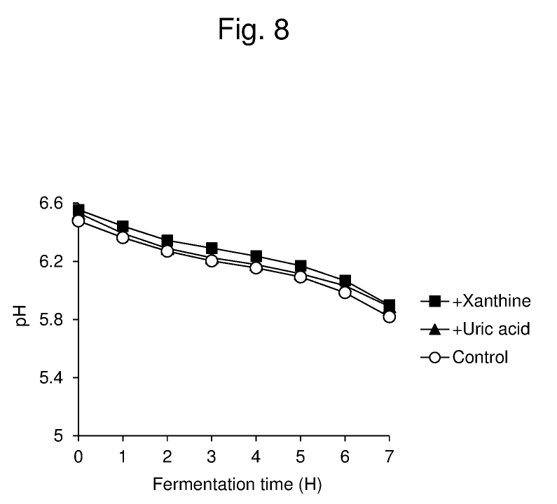

Additionally, guanine which is a purine base; derivatives thereof that are guanosine and deoxyguanosine; and xanthine and uric acid were tested for the fermentation promoting effect by the same method as above, using them as test substances. As a result, as shown in FIG. 7 and FIG. 8, these compounds did not exhibit the fermentation promoting effects.

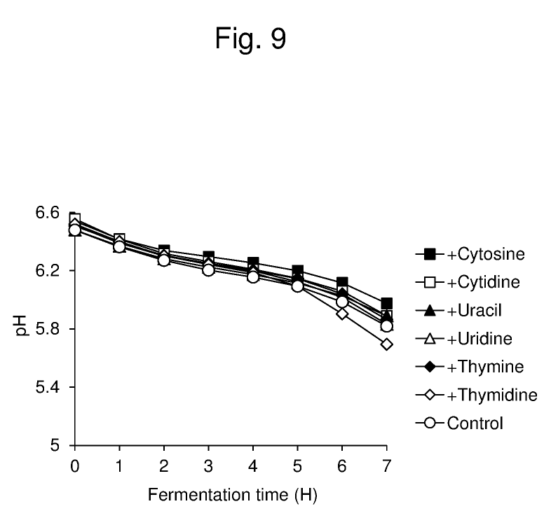

Further, cytosine, uracil, thymine which are pyrimidine bases and derivatives thereof that are cytidine, uridine, and thymidine were tested for the fermentation promoting effect on S. thermophilus by the same method as above, using them as test substances. As a result, as shown in FIG. 9, cytosine, uracil, thymine, cytidine, uridine, and thymidine all did not exhibit the fermentation promoting effects (FIG. 9).

### [Example 3] Fermentation Promoting Effect on Various Streptococcus thermophilus Strains

Inosinic acid was added to UHT sterilized milk at a concentration of 0.05 mmol/kg, and warmed to 43° C. To the warmed UHT sterilized milk, S. thermophilus strain was inoculated in an amount of 1% (vol/wt), and the fermentation was started at 43° C.

As the S. thermophilus strains, six strains of S. thermophilus OLS3059 strain (accession number FERM BP-10740), S. thermophilus OLS3294 strain (accession number NITE P-77), S. thermophilus OLS3289 strain (ATCC 19258), S. thermophilus OLS3469 strain (IFO 13957/NBRC 13957), S. thermophilus OLS3058 strain, and S. thermophilus OLS3290 strain (accession number FERM BP-19638) were used individually.

Herein, the preparation of the six S. thermophilus strains were carried out basically in accordance with the preparation method of S. thermophilus OLS3059 strain described in Example 1. OLS3059 strain and OLS3294 strain were inoculated in an amount of 1% (vol/wt), OLS3289 strain, OLS3469 strain, and OLS3058 strain were inoculated in an amount of 1.5% (vol/wt), and OLS3290 strain was inoculated in an amount of 3% (vol/wt) to the UHT sterilized milk so that an equal number of bacterial cells were added.

Additionally, as a control, the fermentation using UHT sterilized milk without inosinic acid was also carried out.

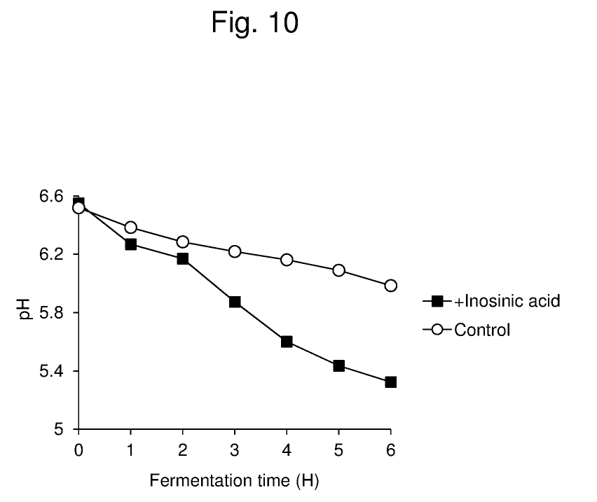

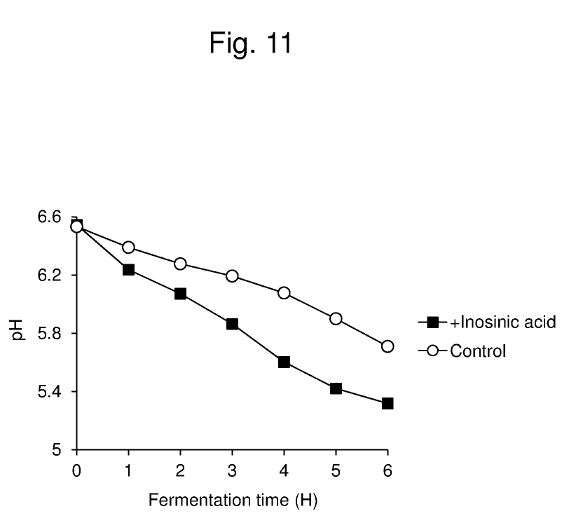

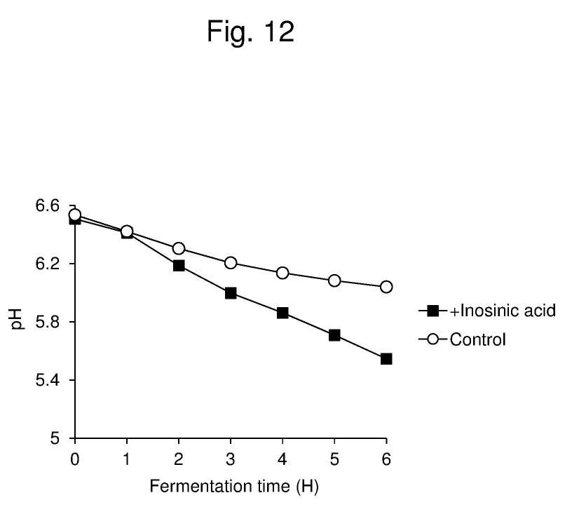

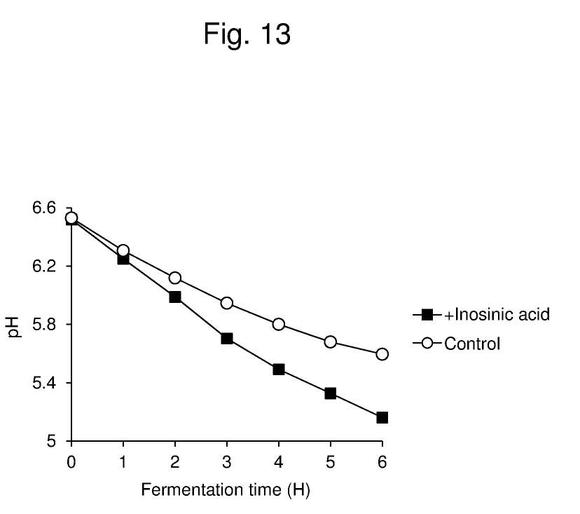

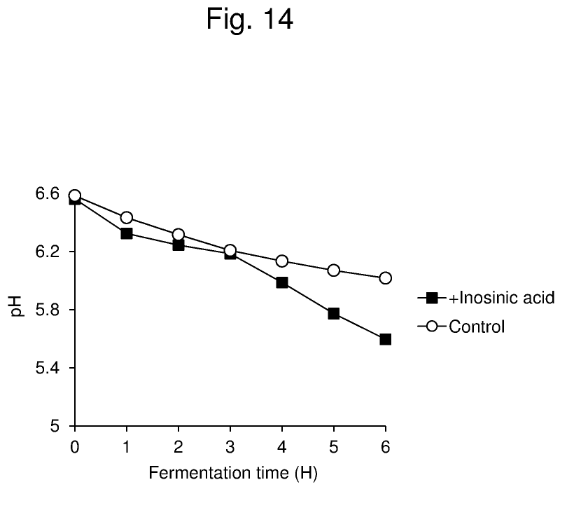

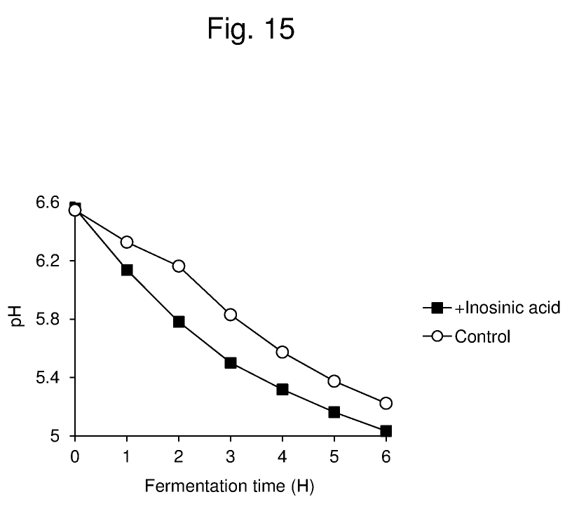

The pH of the fermentation liquid was measured (monitored) over time. The measurement results are shown in FIGS. 10 to 15. The fermentation promoting effect of inosinic acid was shown on all the S. thermophilus strains tested.

These results indicated that inosinic acid exhibits the fermentation promoting effect on various S. thermophilus strains.

### [Example 4] Fermentation Promoting Effect in Mixed Fermentation of S. thermophilus and L. bulgaricus

In the present Example, the fermentation promoting effect of purines on S. thermophilus was tested in mixed-culture (co-culture) of Streptococcus thermophilus (S. thermophilus) and Lactobacillus delbrueckii subsp. bulgaricus (hereinafter, also called as L. bulgaricus) as starters, which are the bacterial species used for the production of yogurt.

Sodium inosinate (Na-inosinate) and a 1:1 mixture of sodium inosinate and sodium guanylate were used as test substances.

Two types of starters were used. The first starter (starter A) was obtained by mixing S. thermophilus OLS3059 strain and L. bulgaricus OLL1073R-1 strain (accession number FERM BP-10741), culturing the strains to a high concentration, and freezing the culture. The second starter (starter B) was obtained by mixing S. thermophilus OLS3294 strain and L. bulgaricus OLL1255 strain (accession number NITE BP-76), culturing the strains to a high concentration and freezing the culture. These starters were inoculated to a fermentation broth base prepared in accordance with the mixing proportions shown in Table 2. Specifically, UHT sterilized milk, powdered skim milk, sucrose, stevia, and water (Table 2) were mixed together to prepare a fermentation broth base, which was then sterilized at 95° C. Subsequently, sodium inosinate (Na-inosinate), or the 1:1 mixture of Na-inosinate and sodium guanylate (Na-guanylate) was added to the fermentation broth base of test groups, and then the starter was inoculated thereto in an amount of 0.05% (vol/wt). The starter was inoculated in an amount of 0.15% (vol/wt) to the fermentation broth base of a control. After inoculation of the starter, the fermentation was started at 43° C.

TABLE 2

| | Mixing Proportions (%) | | |
|---|---|---|---|
| | | Test groups | |
| | | | 1:1 Mixture of |
| | | | Na-inosinate and |
| Ingredients | Control group | Na-inosinate | Na-guanylate |
| UHT sterilized milk | 77.0 | 77.0 | 77.0 |
| Powdered skim milk | 2.8 | 2.8 | 2.8 |
| Sucrose | 4.5 | 4.5 | 4.5 |
| Stevia | 0.0075 | 0.0075 | 0.0075 |
| Na-inosinate | — | 0.025 | — |
| 1:1 Mixture of | — | — | 0.025 |
| Na-inosinate and | | | |
| Na-guanylate | | | |
| Starter | 0.15 | 0.05 | 0.05 |
| Water | 15.54 | 15.62 | 15.62 |

Each mixing proportion is a value relative to the total weight of the fermentation broth base. The proportion of the starter is expressed in % (vol/wt), and the proportions of other ingredients are expressed in % (wt/wt).

After the beginning of the fermentation, the acidities of the fermentation liquids were measured over time. Specifically, 0.5 mL of phenolphthalein was added to 9 g of the fermentation liquid and then 0.1N NaOH was added until the fermentation liquid turned pale red, for neutralization titration. The lactic acid concentration (%) of the fermentation liquid was calculated assuming the whole amount of 0.1N NaOH required for titration corresponds to the amount of lactic acid, and used as the acidity (%).

Further, the L-lactic acid concentration of the fermentation liquid after the beginning of fermentation was measured over time with high performance liquid chromatography (HPLC). The HPLC measurement conditions employed are shown in Table 3.

TABLE 3
HPLC measurement conditions

| | |
|---|---|
| HPLC | Shimadzu SCL-10A SP system (Shimadzu) |
| Column | Sumichiral OA 5000 column, 4.6 mm × 150 mm, 5 μm |
| | (Sumika Chemical Analysis Service) |
| Detector | UV (254 nm) |
| Mobile phase | 2 mM CuSO₄(II)•5H₂O and 5% 2-propanol |
| Temperature | 40° C. |
| Flow rate of | 1.0 mL/min |
| mobile phase | |
| Injection | 10 μL |
| volume | |

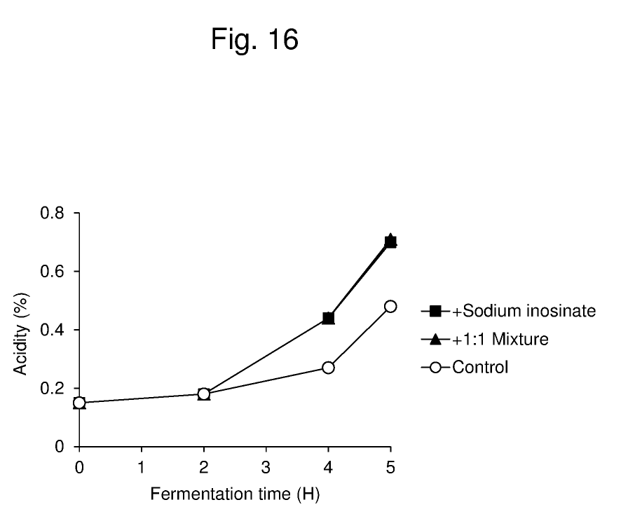

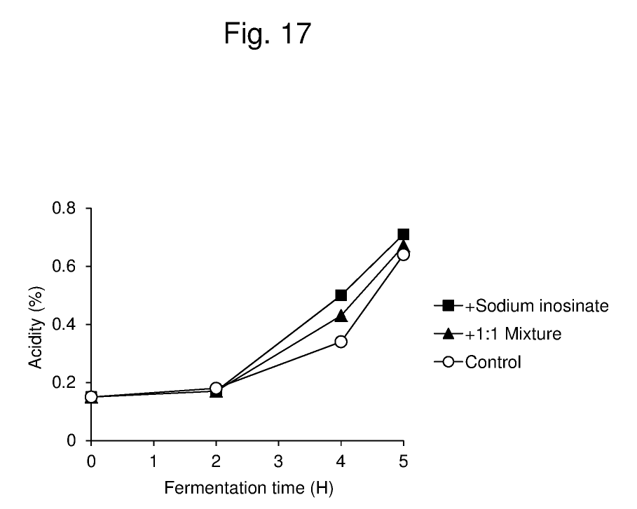

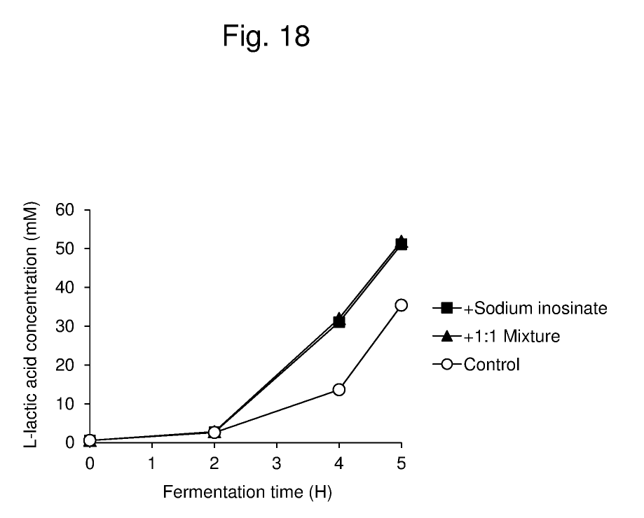

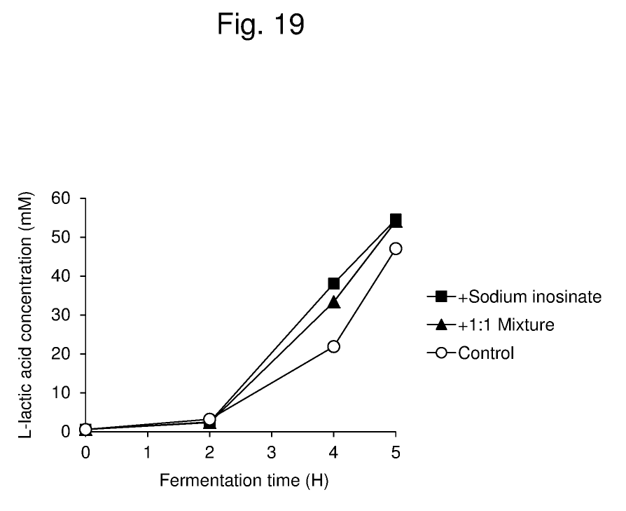

The measurement results are shown in FIGS. 16 to 19. When sodium inosinate or the 1:1 mixture of sodium inosinate and sodium guanylate was used, whichever starter A (FIG. 16) or starter B (FIG. 17) was used, increases in the acidity of the fermentation liquids were shown as compared with the control group despite the starter being inoculated only a third an amount of the control group, indicating that the fermentation were promoted. Further, when sodium inosinate or the 1:1 mixture of sodium inosinate and sodium guanylate was used, whichever starter A (FIG. 18) or starter B (FIG. 19) was used, L-lactic acid production was shown to be promoted as compared with the control group. S. thermophilus is known to produce L-lactic acid, and L. bulgaricus is known to produce D-lactic acid (Microorganism, Vol. 6, No. 1, p 2-3 (1990); Modern Media, Vol. 57, No. 10, p 277-287 (2011)). The measurement of L-lactic acid concentration enables the determination of fermentation level by only S. thermophilus even in the mixed fermentation of S. thermophilus and L. bulgaricus. Thus, the result of the L-lactic acid production having been promoted means that the fermentation by S. thermophilus was promoted even in the mixed fermentation (mixed-culture) of S. thermophilus and L. bulgaricus.

These results revealed that purines promote fermentation of S. thermophilus at least, in mixed fermentation of S. thermophilus and L. bulgaricus.

### [Example 5] Influence of Sodium Inosinate on Taste in Yogurt Fermentation

Yogurts were prepared using sodium inosinate as a test substance in accordance with the mixing proportions shown in Table 4. Specifically, the ingredients other than the yeast extract, sodium inosinate and the starter indicated in Table 4 were mixed to prepare a yogurt base, the yogurt base was sterilized at 95° C., and subsequently sodium inosinate was added (sodium inosinate group). For taste comparisons, a test group in which a yeast extract known as a fermentation promoting agent, instead of sodium inosinate, was added (yeast extract group) and a control group in which neither sodium inosinate or yeast extract was added were prepared (Table 4). The yogurt bases of these groups were sterilized at 90° C. before the inoculation of the starter.

TABLE 4

| | Mixing Proportions (%) | | |
|---|---|---|---|
| | Control | Yeast extract | Sodium inosinate |
| Ingredients | group | group | group |
| UHT sterilized milk | 77.0 | 77.0 | 77.0 |
| Powdered skim milk | 2.8 | 2.8 | 2.8 |
| Whey protein | 0.2 | 0.2 | 0.2 |
| Sucrose | 4.5 | 4.5 | 4.5 |
| Stevia | 0.0075 | 0.0075 | 0.0075 |
| Yeast extract | — | 0.01 | — |
| Sodium inosinate | — | — | 0.0008 |
| Starter | 0.15 | 0.05 | 0.05 |
| Water | 15.34 | 15.43 | 15.44 |

Each mixing proportion is a value relative to the total weight of the fermentation broth base The proportion of the starter is expressed in % (vol/wt), and the proportions of other ingredients are expressed in % (wt/wt).

A frozen starter was prepared by mixing L. bulgaricus OLL1255 strain (accession number NITE BP-76) and S. thermophilus OLS3294 strain (accession number NITE P-77), culturing the strains to a high concentration, and freezing the culture. The starter was inoculated in an amount of 0.05% (vol/wt) for the yeast extract group and the sodium inosinate group, and in an amount of 0.15% (vol/wt) for the control group. After starter inoculation, the fermentation was conducted at 43° C. until the acidity of a fermentation liquid reached 0.75%, and subsequently the fermentation liquid was cooled at 5° C., thereby preparing yogurt.

The prepared yogurt was evaluated for taste by five expert panels trained in sensory evaluation of yogurt. Each of the evaluation items: curd physical property, acidity, sweetness, and unpleasant taste of the yogurt was scored on a 5-point scale. The average score in the control group of each evaluation item was set as 1, and the relative value of the average score in each of the yeast extract group and the sodium inosinate added group was calculated relative to that of the control group. The physical property was evaluated in view of “smoothness” and “firmness”. The results are shown in Table 5.

TABLE 5

| | Control | Yeast extract | Sodium inosinate |
|---|---|---|---|
| | group | group | group |
| Physical property of curd | 1.0 | 1.0 | 1.2 |
| Sourness | 1.0 | 1.2 | 1.4 |
| Sweetness | 1.0 | 0.9 | 0.8 |
| Unpleasant taste such as | 1.0 | 1.8 | 1.0 |
| bitterness and harsh taste | | | |

As a result, there was little difference in the physical property, sourness, and sweetness among the yogurts of these groups. The yogurt of the yeast extract group markedly inferior in terms of the unpleasant taste. On the other hand, the yogurt of the sodium inosinate group had no difference in the unpleasant taste from that of the control group. As seen in the details of the evaluation results on the unpleasant taste, three panels clearly sensed the unpleasant tastes in the yogurt prepared adding the yeast extract, whereas no panel sensed the unpleasant taste in the yogurt prepared adding sodium inosinate as well as the yogurt prepared adding neither the yeast extract nor sodium inosinate (Control). Thus, sodium inosinate was superior to the yeast extract in that it has little adverse influence on the taste of yogurt.

In addition, in the fermentation of the yogurt in which sodium inosinate or the yeast extract was added, the time for completion of the fermentation was shortened by more than 2 hours compared with the control, even though the amount of the starter inoculated was only ⅓ of that in the control. This indicates that sodium inosinate also notably promotes the fermentation for yogurt production.

### [Example 6] Evaluation of Cryoprotecting Effect on Starter for Purines

In the present Example, purines added to a mixed starter of S. thermophilus and L. bulgaricus were examined for the cryoprotecting effect. As purines, sodium inosinate and a 1:1 mixture of sodium inosinate and sodium guanylate were used.

A frozen starter prepared by mixing S. thermophilus OLS3059 strain and L. bulgaricus OLL1073R-1 strain, culturing the strains to a high concentration and freezing the culture, and a frozen starter prepared by mixing S. thermophilus OLS3294 strain and L. bulgaricus OLL1255 strain, culturing the strains to a high concentration, and freezing the culture, were used. These frozen starters were thawed, divided into the following 3 groups, and refrozen with or without adding purines:

1) the thawed starter being refrozen as is without adding anything the thawed starter (Control),

2) the thawed starter being added with 2.8% (wt/wt) of sodium inosinate and refrozen, and

3) the thawed starter being added with 2.8% (wt/wt) of a 1:1 mixture of sodium inosinate and sodium guanylate and refrozen.

Subsequently, the fermentation was carried out using the refrozen starters prepared in Groups 1) to 3) and the fermentation ability of the starters was examined. The fermentation broth base was prepared, in accordance with the mixing proportions indicated in Table 6, by mixing the ingredients other than sodium inosinate or the 1:1 mixture of sodium inosinate and sodium guanylate, and sterilizing it at 95° C., followed by adding sodium inosinate or the 1:1 mixture of sodium inosinate and sodium guanylate. The refrozen starter of 1) was inoculated in an amount of 0.05% (vol/wt) into the fermentation broth base prepared in accordance with the mixing proportions of B and C indicated in Table 6, and the fermentation was carried out. The refrozen starter of 2) or 3) was inoculated in an amount of 0.05% (vol/wt) into the fermentation broth base prepared in accordance with the mixing proportions of A) indicated in Table 6, and the fermentation was started at 43° C. For both the combination of the frozen starter 1) and the mixing proportions of B (the fermentation broth base supplemented with sodium inosinate) and the combination of the frozen starter 2) and the mixing proportions of A (sodium inosinate being added during starter freezing), a sodium inosinate concentration at the time of starting the fermentation was 0.0014% (wt/wt). Likewise, for the combination of the frozen starter 1) and mixing proportions of C (the fermentation broth base supplemented with the 1:1 mixture of sodium inosinate and sodium guanylate) and the combination of the frozen starter 3) and the mixing proportions of A (the 1:1 mixture starter of sodium inosinate and sodium guanylate being added during starter freezing), equal concentrations of purines at the time of starting the fermentation were used.

TABLE 6

| | Mixing | | |
|---|---|---|---|
| | proportions (% (wt/wt)) | | |
| Ingredients | A | B | C |
| UHT sterilized milk | 77.0 | 77.0 | 77.0 |
| Powdered skim milk | 2.8 | 2.8 | 2.8 |
| Sucrose | 4.5 | 4.5 | 4.5 |
| Na-inosinate | — | 0.0014 | — |
| 1:1 Mixture of Na-inosinate and | — | — | 0.0014 |
| Na-guanylate | | | |
| Water | 15.7 | 15.7 | 15.7 |

The mixing proportions are expressed in % (wt/wt) relative to the total weight of the fermentation broth base

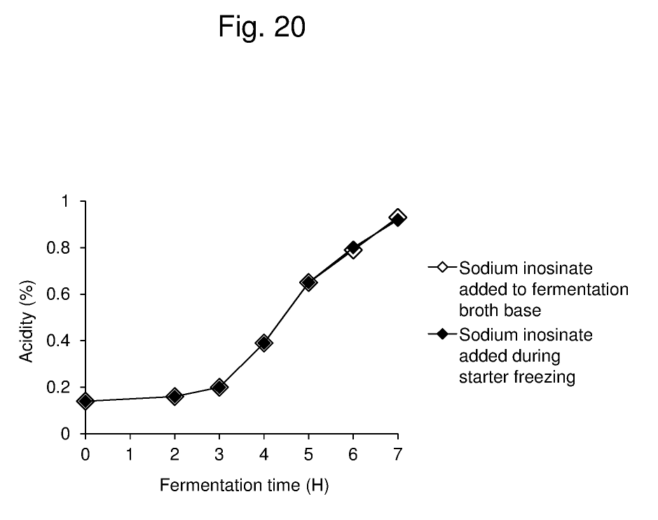

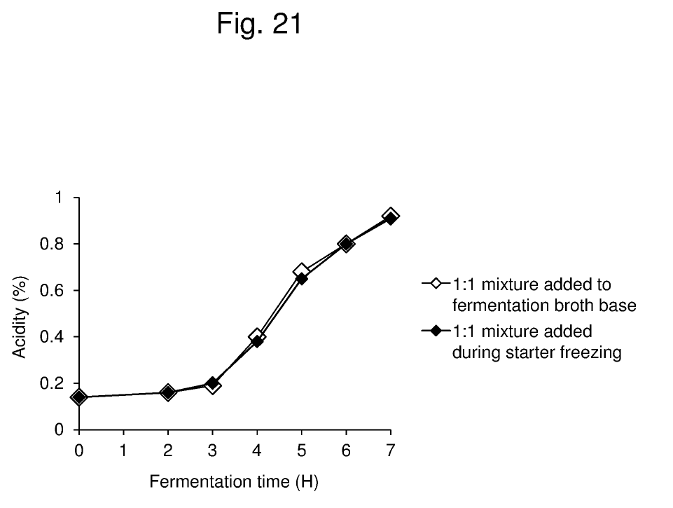

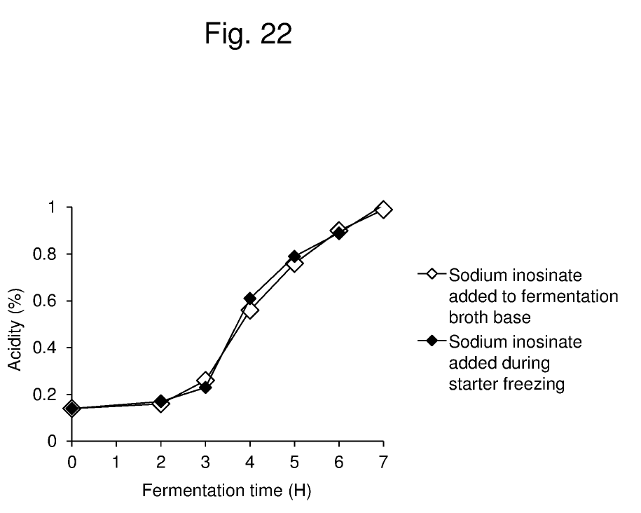

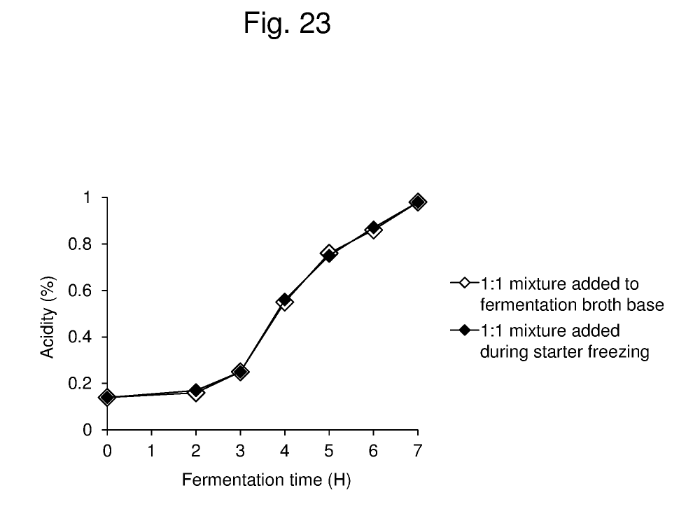

After the beginning of the fermentation had started, the acidities of the fermentation liquids were measured over time. The measurement results are shown in FIGS. 20 to 23. In the tests using the mixed frozen starter of S. thermophilus OLS3059 strain and L. bulgaricus OLL1073R-1 strain, there was little difference in the fermentation level between the combination of the frozen starter 1) and the mixing proportions of B and the combination of the frozen starter 2) and the mixing proportions of A (FIG. 20). Further, there was also little difference in the fermentation level between the combination of the frozen starter 1) and the mixing proportions of C and the combination of the frozen starter 3) and the mixing proportions of A (FIG. 21). Likewise, in the test using the mixed frozen starter of S. thermophilus OLS3294 strain and L. bulgaricus OLL1255 strain, there was little difference in the fermentation level between the combination of the frozen starter 1) and the mixing proportions of B and the combination of the frozen starter 2) and the mixing proportions of A (FIG. 22). Further, there was also little difference in the fermentation level between the combination of the frozen starter 1) and the mixing proportions of C and the combination of the frozen starter 3) and the mixing proportions of A (FIG. 23).

The above results demonstrated that sodium inosinate and the 1:1 mixture of sodium inosinate and sodium guanylate had equal effects on the fermentation when added to fermentation broth base and when added to frozen starters. If sodium inosinate and the 1:1 mixture of sodium inosinate and sodium guanylate exhibited the cryoprotecting effect on the lactic acid bacteria, in a group in which each of them was added to a frozen starter, the fermentation would be presumably more promoted as compared with the group in which each of them was added to a fermentation broth base. However, as shown in FIGS. 20 to 23, actually there was no difference in the fermentation level between these groups, whereby it was demonstrated that sodium inosinate and a 1:1 mixture of sodium inosinate and sodium guanylate had no cryoprotecting effect on lactic acid bacteria.

### [Example 7] Fermentation Promoting Effect of Mixture of Adenosine or Inosine and Guanosine

The fermentation promoting effect on S. thermophilus was examined by the same method as described in Example 2, except that mixtures of adenosine and guanosine in different mixing ratios or mixtures of inosine and guanosine in different mixing ratios were used as test substances.

The test substances used are mixtures of adenosine and guanosine prepared in mixing ratios (weight ratio) of 10:0 (only adenosine), 7:3, 5:5, and 3:7; and mixtures of inosine and guanosine prepared in mixing ratios (weight ratio) of 10:0 (only inosine), 7:3, 5:5, and 4:6. The test substances were added to UHT sterilized milk in an amount such that the total concentration of both compounds was 0.05 mmol/kg.

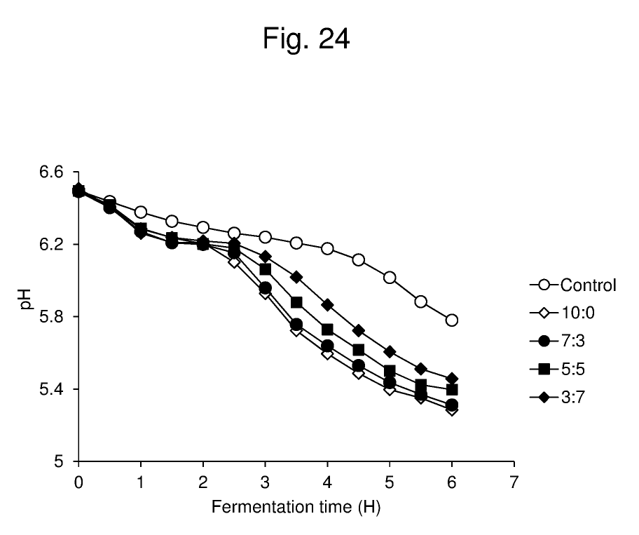

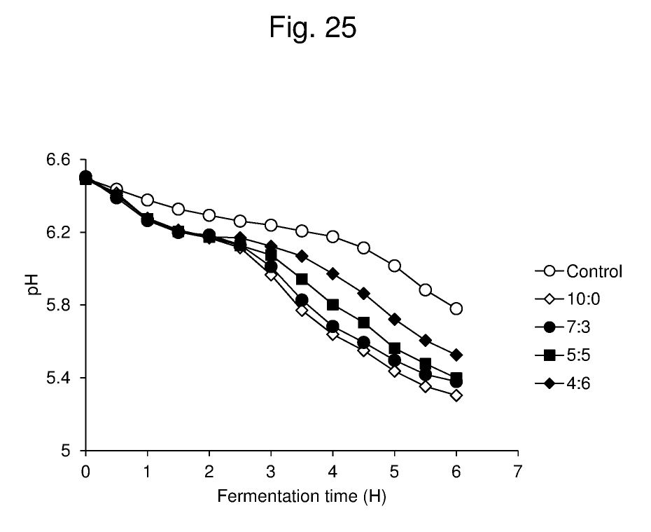

The results of measuring the pH of the fermentation liquids over time in the fermentation of S. thermophilus in the presence of these test substances are shown in FIG. 24 (adenosine and guanosine) and FIG. 25 (inosine and guanosine). As the mixing ratio of guanosine increased, the fermentation promoting effect decreased, whereby it has been shown that guanosine does not exhibit the fermentation promoting effect on S. thermophilus, while adenosine and inosine exhibit the fermentation promoting effect in a concentration-dependent manner.

### [Example 8] Fermentation Promoting Effect of Sodium Inosinate on Lactic Acid Bacteria Other than S. thermophilus-1

The fermentation promoting effect of sodium inosinate (Na-inosinate) was examined in the fermentation of Lactobacillus bacteria, a Lactococcus bacterium, and a Leuconostoc bacterium indicated in Table 7. The fermentation was carried out using UHT sterilized milk at 43° C., and sodium inosinate was added in a concentration of 0.002% (wt/wt). Starters (bacterial suspensions) were prepared from the respective bacterial strains by the same method as described in Example 1. The starter was inoculated in an inoculation amount of 1% (vol/wt). Except for these points, the fermentation promoting effect was evaluated in the same manner as in Example 1.

TABLE 7

| | |
|---|---|
| Lactobacillus delbrueckii subsp. bulgaricus | (FERM BP-10741) |
| OLL1073R-1 | |
| Lactobacillus delbrueckii subsp. lactis OLL2693 | (JCM1148) |
| Lactobacillus gasseri OLL2716 | (FERM BP-6999) |
| Lactobacillus helveticus OLL1482 | (JCM1120T) |
| Lactococcus lactis subsp. lactis OLS3445 | |
| Leuconostoc lactis OLS5167 | (JCM6123T) |

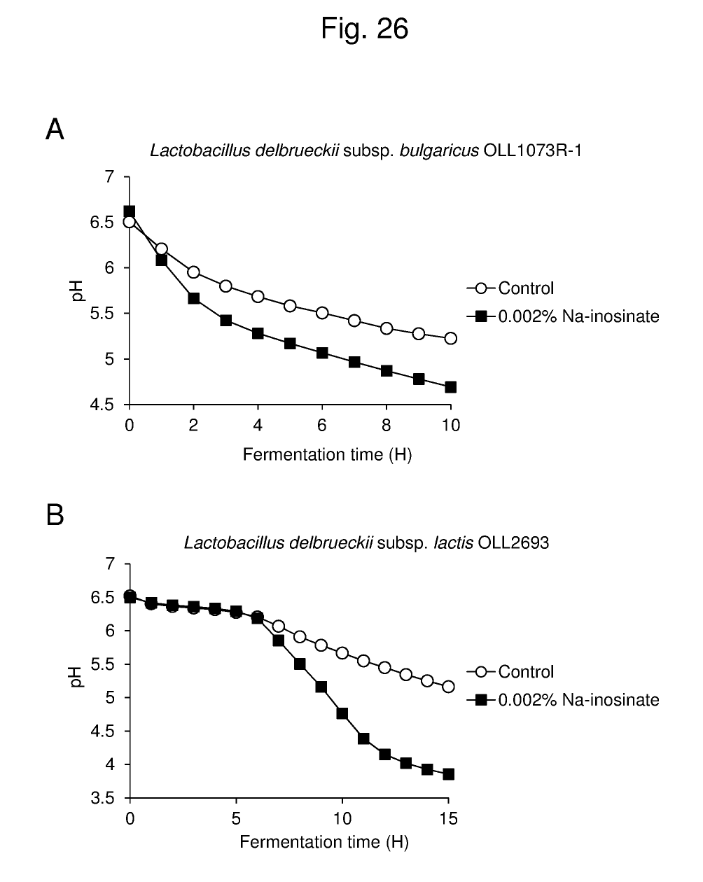

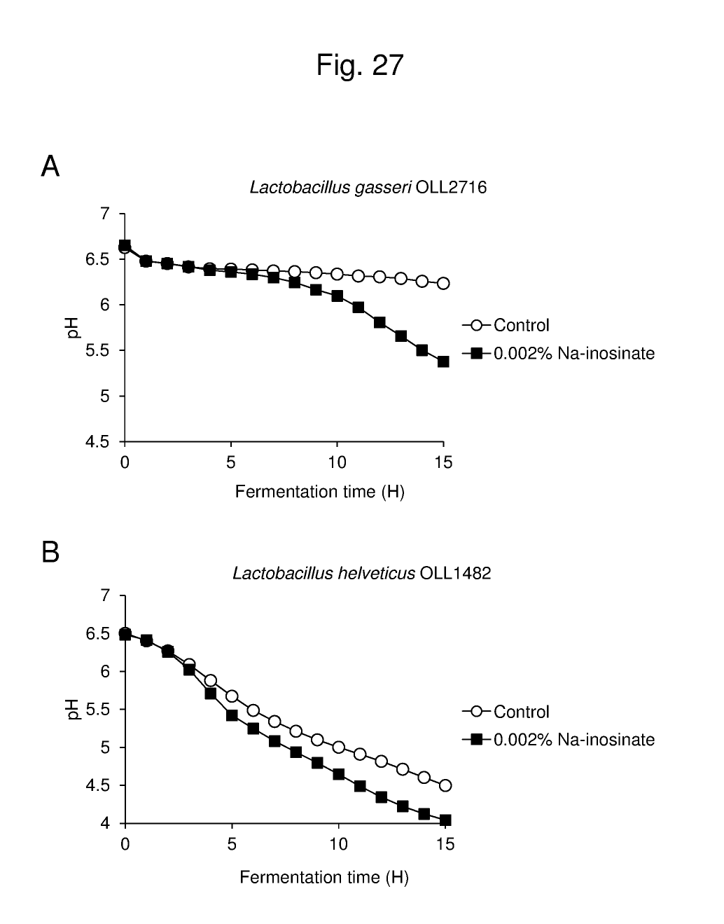

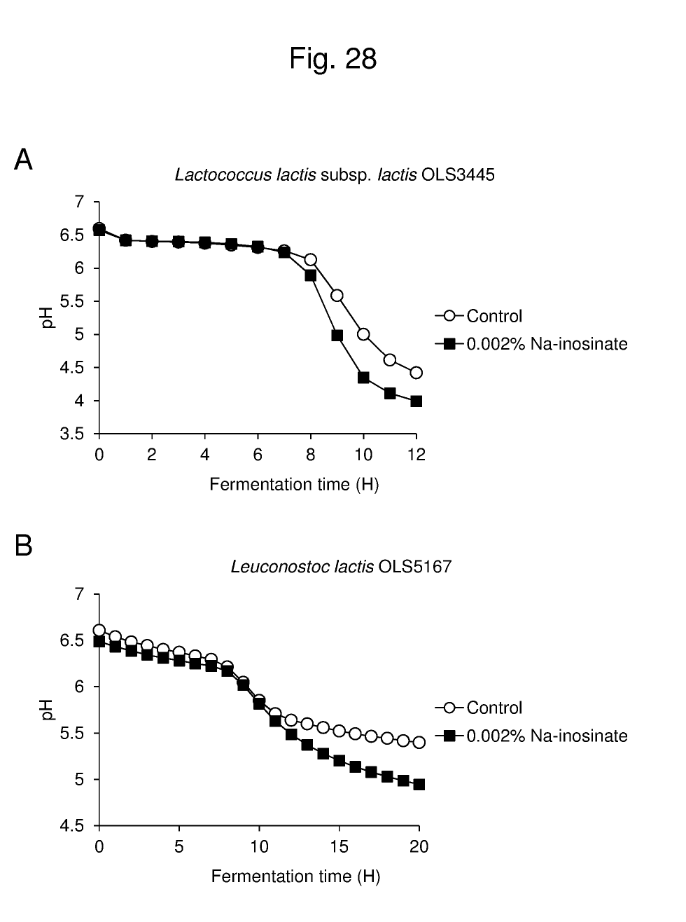

As a result, the fermentation promoting effect of the addition of sodium inosinate was shown in all the strains tested (FIGS. 26 to 28).

### [Example 9] Fermentation Promoting Effect of Sodium Inosinate on Lactic Acid Bacteria Other than S. thermophilus-2

The fermentation promoting effect of sodium inosinate was examined in the fermentation of the lactic acid bacterial strains indicated in Table 8. The fermentation was carried out at 43° C. using UHT sterilized milk supplemented with 0.2% (wt/wt) of casein-hydrolyzed peptide (FrieslandCampina, Hyvital®Casein CMA 500), and in the fermentation 0.002% (wt/wt) of sodium inosinate (percent (%) relative to the total amount of UHT sterilized milk and casein-hydrolyzed peptide; the same applies to the subsequent Examples) was added. The preparation method and the inoculation amount (%) of the starter are as described in Example 1. The casein-hydrolyzed peptide was added to supplement amino acid. Except for these points, the fermentation promoting effect was evaluated in the same manner as in Example 1.

TABLE 8

| | |
|---|---|
| Lactobacillus acidophilus OLL1836 | (JCM1132T) |
| Lactobacillus johnsonii OLL2725 | (JCM2012T) |
| Lactobacillus casei OLL2230 | (JCM1124T) |
| Lactobacillus fermentum OLL2690 | (JCM1120T) |
| Lactococcus lactis subsp. diacetylactis OLS3021 | |
| Lactococcus lactis subsp. cremoris OLS3313 | |

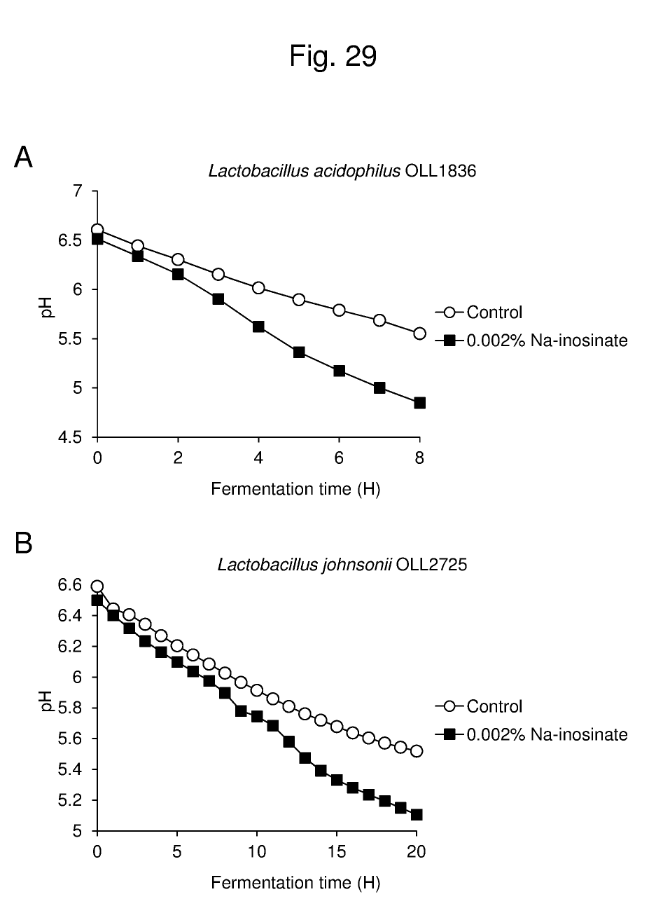

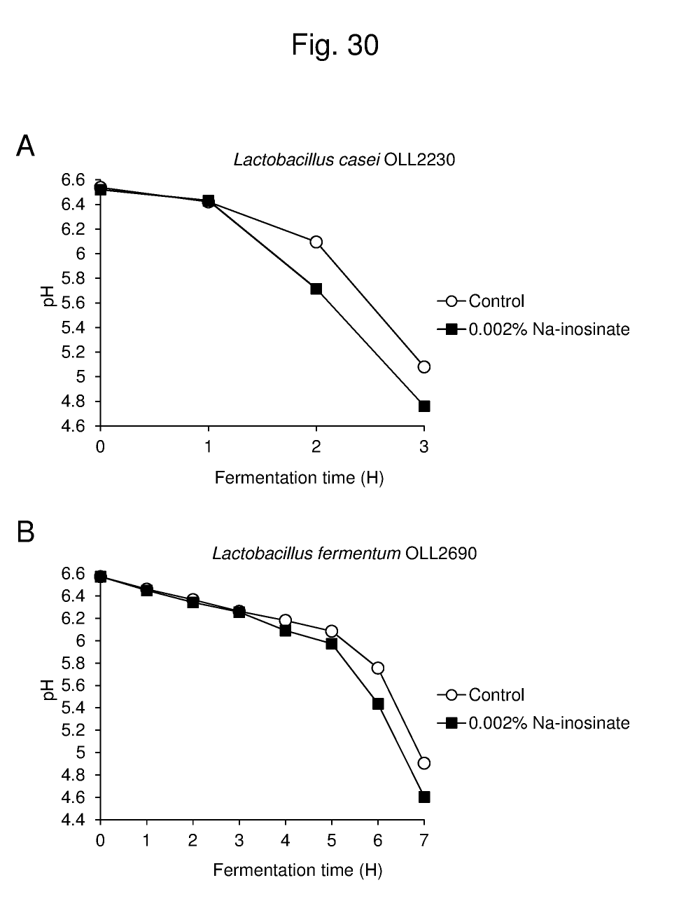

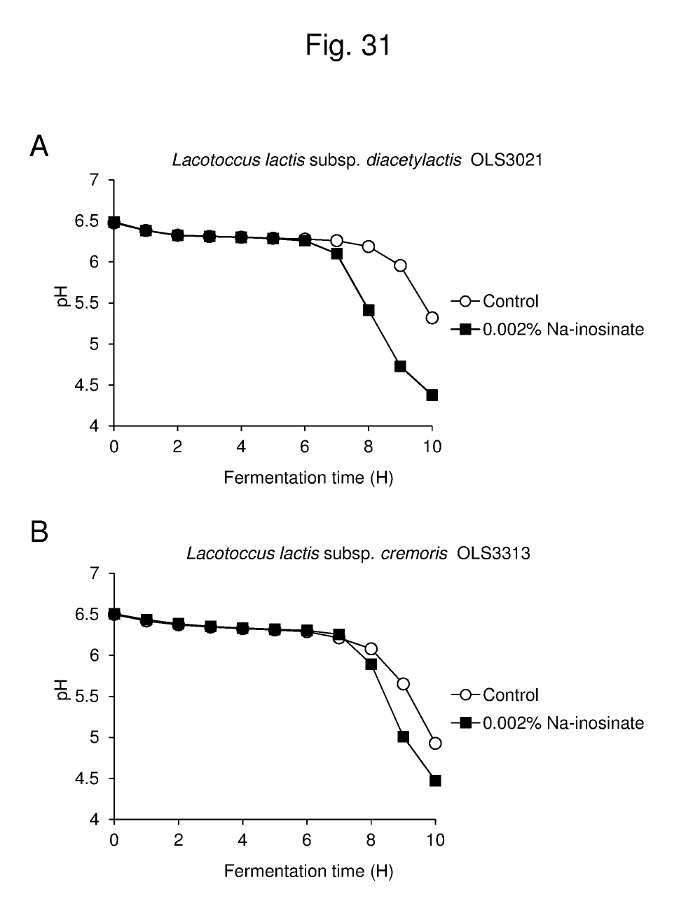

As a result, the fermentation promoting effect of the addition of sodium inosinate was shown in all the strains tested (FIGS. 29 to 31).

### [Example 10] Fermentation Promoting Effect of Sodium Inosinate on Lactobacillus delbrueckii Strains

The fermentation promoting effects of sodium inosinate (Na-inosinate) and a 1:1 mixture of sodium inosinate and sodium guanylate (also called “1:1 mixture”) were examined in the fermentation of Lactobacillus delbrueckii strains indicated in Table 9. The fermentation was carried out at 43° C. using UHT sterilized milk supplemented with 0.2% (wt/wt) of casein-hydrolyzed peptide (FrieslandCampina, Hyvital®Casein CMA 500), and in the fermentation 0.002% (wt/wt) of sodium inosinate, or 0.025% (wt/wt) of the 1:1 mixture of sodium inosinate and sodium guanylate was added. The preparation method and the inoculation amount (%) of the starter are as described in Example 1. Except for these points, the fermentation promoting effect was evaluated in the same manner as in Example 1.

TABLE 9

| | |
|---|---|
| Lactobacillus delbrueckii subsp. bulgaricus | (FERM BP-11269) |
| OLL1181 | |
| Lactobacillus delbrueckii subsp. bulgaricus | (NITE BP-76) |
| OLL1255 | |
| Lactobacillus delbrueckii subsp. lactis OLL2708 | (JCM1557) |
| Lactobacillus delbrueckii subsp. delbrueckii | (JCM20075) |
| OLL203471 | |
| Lactobacillus delbrueckii subsp. indicus | (JCM15610T) |
| OLL203412 | |

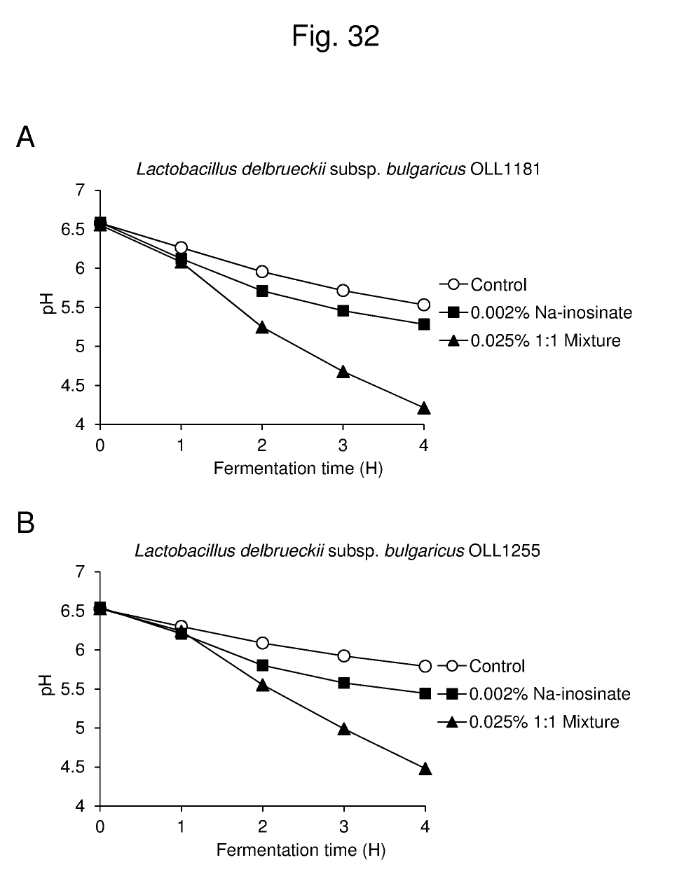

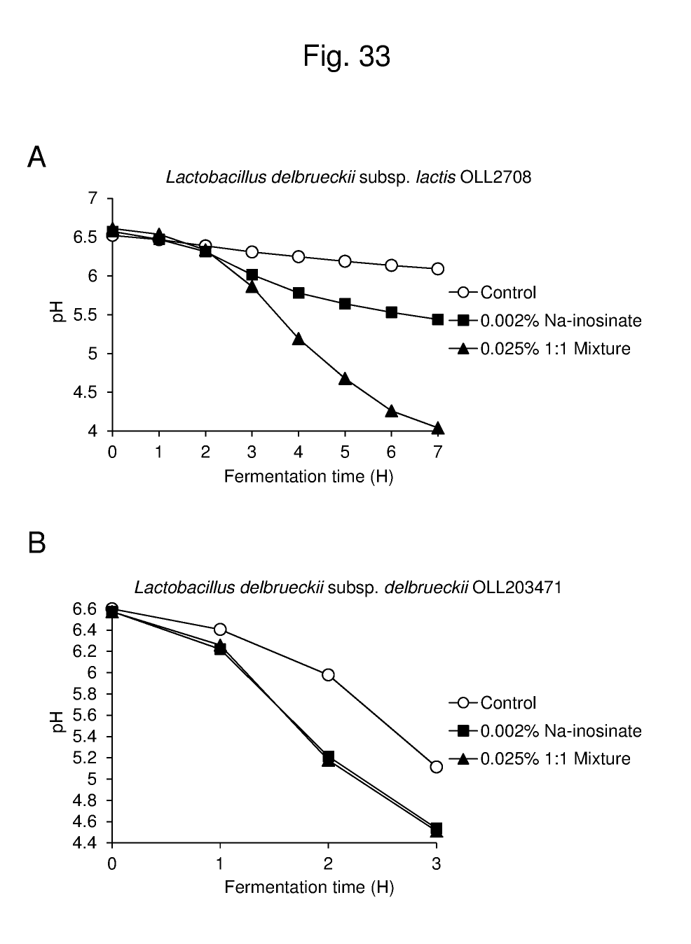

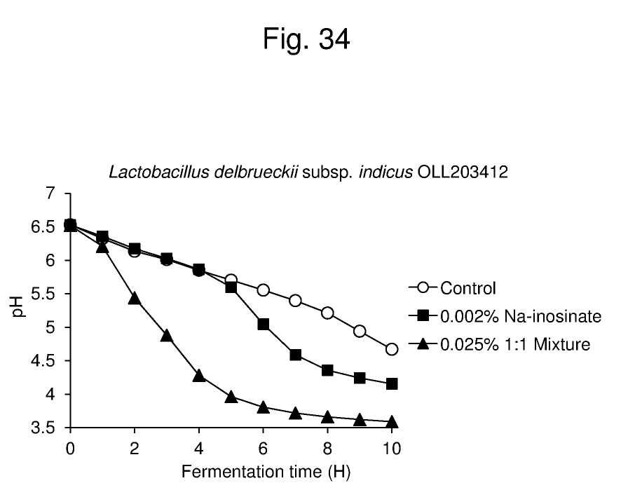

As a result, the fermentation promoting effect of the addition of sodium inosinate or the 1:1 mixture of sodium inosinate and sodium guanylate was shown in all the strains tested (FIGS. 32 to 34).

### [Example 11] Fermentation Promoting Effects of Sodium Inosinate and 1:1 Mixture of Sodium Inosinate and Sodium Guanylate on Lactobacillus Species

The fermentation promoting effects of sodium inosinate and a 1:1 mixture of sodium inosinate and sodium guanylate were examined in the fermentation of the Lactobacillus acidophilus or Lactobacillus johnsonii strain indicated in Table 10. The fermentation was carried out at 43° C. using UHT sterilized milk supplemented with 0.2% (wt/wt) of casein-hydrolyzed peptide (FrieslandCampina, Hyvital®Casein CMA 500), and in the fermentation 0.002% (wt/wt) of sodium inosinate, or 0.025% (wt/wt) of the 1:1 mixture of sodium inosinate and sodium guanylate was added. The preparation method and the inoculation amount (%) of the starter are as described in Example 1. Except for these points, the fermentation promoting effect was evaluated in the same manner as in Example 1.

TABLE 10

| | |
|---|---|
| Lactobacillus acidophilus OLL1846 | (JCM1023) |
| Lactobacillus johnsonii OLL203276 | (JCM1022T) |

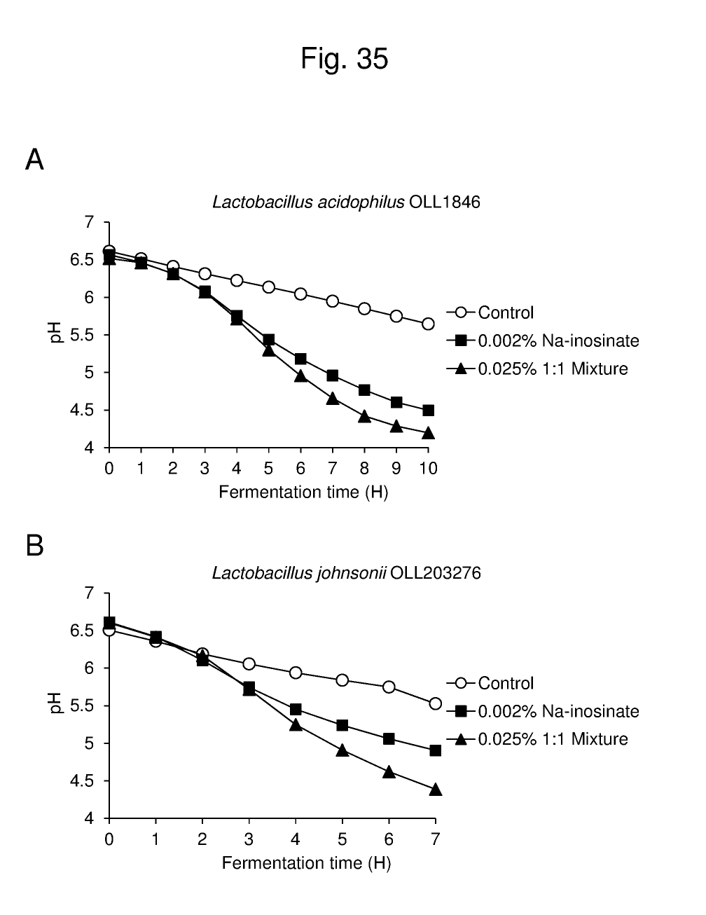

As a result, the fermentation promoting effect of the addition of sodium inosinate, or the 1:1 mixture of sodium inosinate and sodium guanylate was shown in all the strains tested (FIG. 35).

### [Example 12] Fermentation Promoting Effects of Adenylic Acid and a 1:1 Mixture of Sodium Inosinate and Sodium Guanylate on Various Lactic Acid Bacterial Strains

The fermentation promoting effects of adenylic acid (AMP) and a 1:1 mixture of sodium inosinate and sodium guanylate (also called “1:1 mixture”) were examined in the fermentation of bacterial strains of Lactobacillus species indicated in Table 11, and the bacterial strains of the Lactococcus species and the Leuconostoc species indicated in Table 12. The bacterial strains to be used in the present Example were used in any of Examples 8 to 11. The fermentation was carried out at 43° C. using the UHT sterilized milk supplemented with 0.2% (wt/wt) of casein-hydrolyzed peptide (FrieslandCampina, Hyvital®Casein CMA 500), and in the fermentation 0.05 mmol/kg of adenylic acid (about 0.00174% (wt/wt)), or 0.025% (wt/wt) of the 1:1 mixture of sodium inosinate and sodium guanylate was added. The preparation method and the inoculation amount (%) of the starter are as described in Example 1. Except for these points, the fermentation promoting effect was evaluated in the same manner as in Example 1.

TABLE 11

| | |
|---|---|
| Lactobacillus delbrueckii subsp. bulgaricus | (FERM BP-10741) |
| OLL1073R-1 | |
| Lactobacillus gasseri OLL2716 | (FERM BP-6999) |
| Lactobacillus acidophilus OLL1836 | (JCM1132T) |
| Lactobacillus johnsonii OLL2725 | (JCM2012T) |
| Lactobacillus helveticus OLL1482 | (JCM1120T) |

TABLE 12

| | |
|---|---|
| Lactococcus lactis subsp. lactis OLS3445 | |
| Leuconostoc lactis OLS5167 | (JCM6123T) |

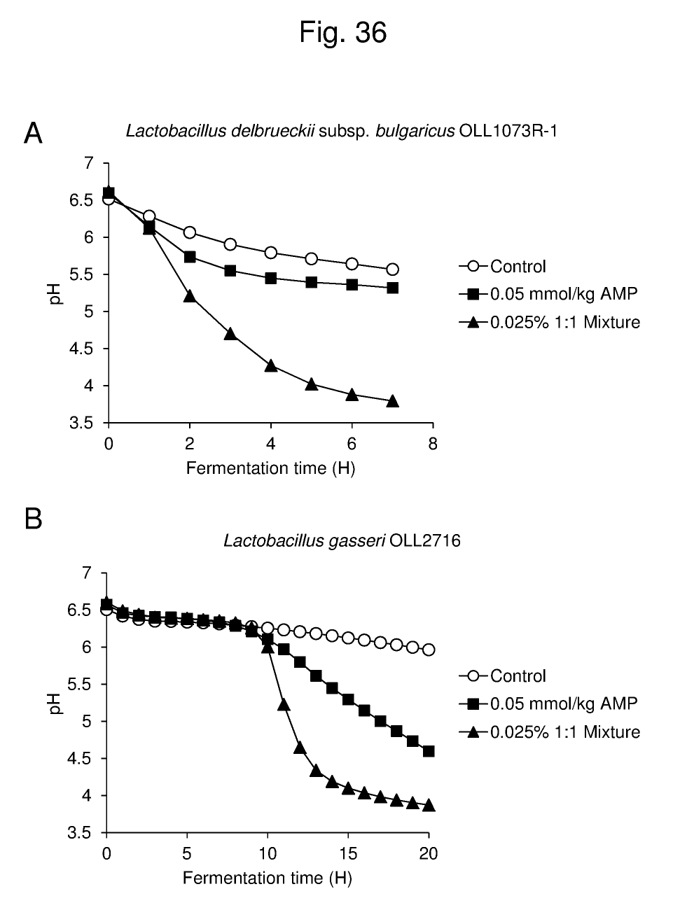

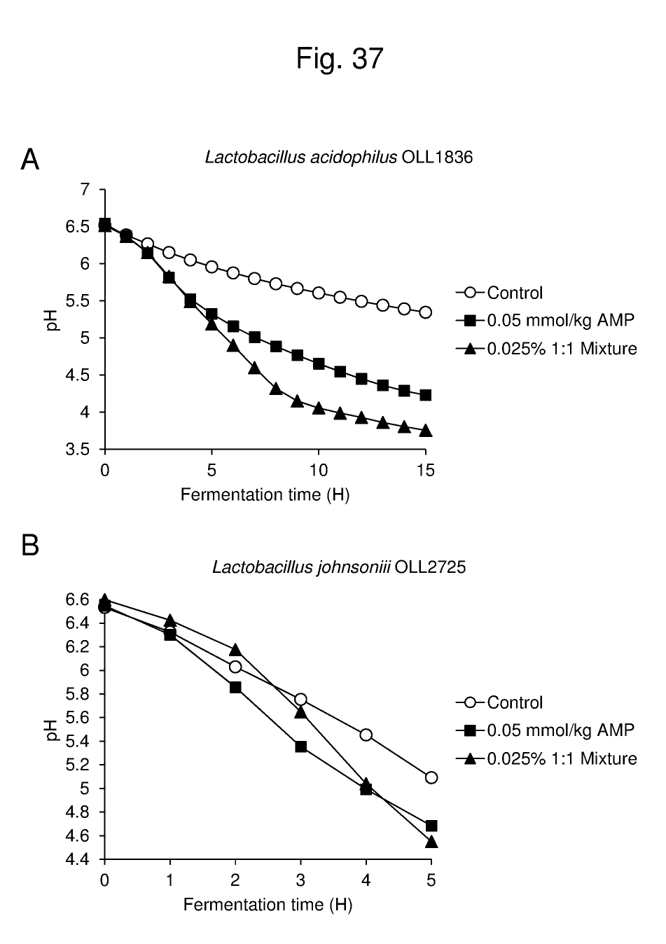

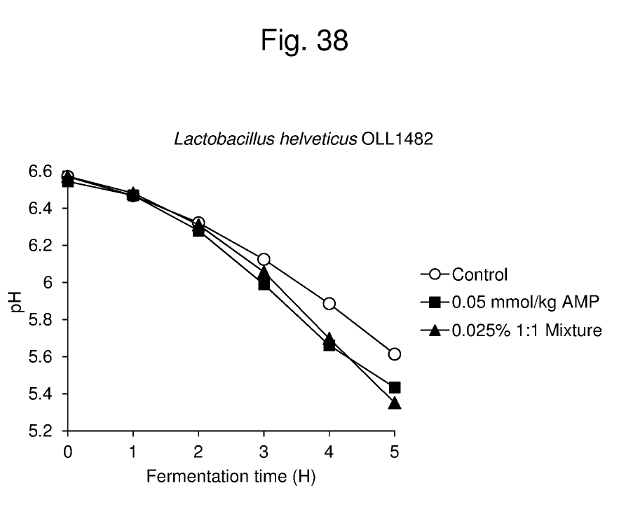

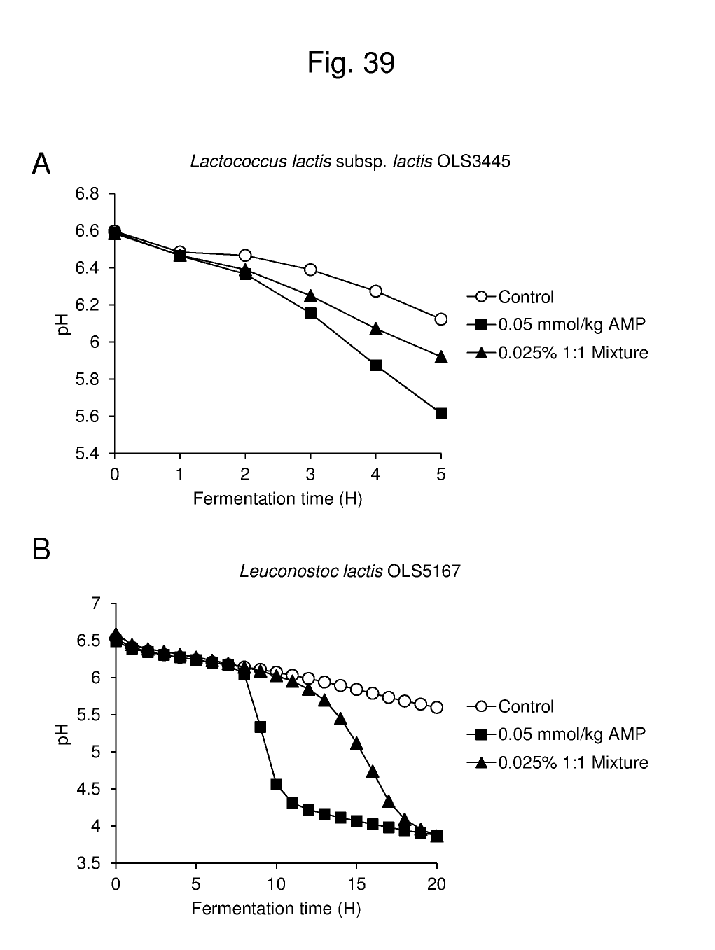

As a result, the fermentation promoting effect of the addition of adenylic acid or the 1:1 mixture of sodium inosinate and sodium guanylate was shown in all the strains tested (FIGS. 36 to 39).

### INDUSTRIAL APPLICABILITY

According to the present invention, materials capable of promoting the fermentation by S. thermophilus even when used in a very small amount, can be provided. The materials can be used to shorten the fermentation process in the production of fermented foods, with little influence (due to unpleasant taste or the like) on the taste of fermented foods such as fermented milk.

All publications, patents, and patent applications cited in the present specification are incorporated herein by reference in their entirety.

1. A fermentation promoting agent for a lactic acid bacterium, comprising a compound having a purine skeleton with a hydrogen atom attached to the carbon atom at position 2.

2. The fermentation promoting agent according to claim 1, wherein said compound is a purine base which is adenine or hypoxanthine, a purine nucleoside or purine nucleotide comprising the base as a constituent, or a salt thereof.

3. The fermentation promoting agent according to claim 1, wherein said compound is selected from the group consisting of adenine, hypoxanthine, adenosine, inosine, deoxyadenosine, deoxyinosine, adenylic acid, and inosinic acid, and salts thereof.

4. The fermentation promoting agent according to claim 1, wherein the lactic acid bacterium is a Streptococcus bacterium.

5. The fermentation promoting agent according to claim 4, wherein the Streptococcus bacterium is Streptococcus thermophilus.

6. The fermentation promoting agent according to claim 1, wherein the lactic acid bacterium is a Lactobacillus bacterium.

7. The fermentation promoting agent according to claim 6, wherein the Lactobacillus bacterium is selected from the group consisting of Lactobacillus delbrueckii, Lactobacillus helveticus, Lactobacillus acidophilus, Lactobacillus johnsonii, Lactobacillus casei, Lactobacillus fermentum, and Lactobacillus gasseri.

8. The fermentation promoting agent according to claim 1, wherein the lactic acid bacterium is a Lactococcus bacterium.

9. The fermentation promoting agent according to claim 8, wherein the Lactococcus bacterium is Lactococcus lactis.

10. The fermentation promoting agent according to claim 1, wherein the lactic acid bacterium is a Leuconostoc bacterium.

11. The fermentation promoting agent according to claim 10, wherein the Leuconostoc bacterium is Leuconostoc lactis.

12. (canceled)

13. A method for promoting lactic acid bacterial fermentation, comprising adding a compound having a purine skeleton with a hydrogen atom attached to the carbon atom at position 2 to a fermentation substrate, and culturing lactic acid bacteria in/on the fermentation substrate to ferment the fermentation substrate.

14. The method according to claim 13, wherein said compound is a purine base which is adenine or hypoxanthine, a purine nucleoside or purine nucleotide comprising the base as a constituent, or a salt thereof.

15. The method according to claim 13, wherein said compound is selected from the group consisting of adenine, hypoxanthine, adenosine, inosine, deoxyadenosine, deoxyinosine, adenylic acid, and inosinic acid, and salts thereof.

16. The method according to claim 13, wherein the lactic acid bacteria comprise at least one selected from the group consisting of a Streptococcus bacterium, a Lactobacillus bacterium, a Lactococcus bacterium, and a Leuconostoc bacterium.

17. The method according to claim 16, wherein the Streptococcus bacterium is Streptococcus thermophilus.

18. The method according to claim 16, wherein the Lactobacillus bacterium is at least one selected from the group consisting of Lactobacillus delbrueckii, Lactobacillus helveticus, Lactobacillus acidophilus, Lactobacillus johnsonii, Lactobacillus casei, Lactobacillus fermentum, and Lactobacillus gasseri.

19. The method according to claim 16, wherein the Lactococcus bacterium is Lactococcus lactis.

20. The method according to claim 16, wherein the Leuconostoc bacterium is Leuconostoc lactis.

21. The method according to claim 13, wherein the lactic acid bacteria are Streptococcus thermophilus and Lactobacillus delbrueckii subsp. bulgaricus and the lactic acid bacteria are mixed-cultured.

22. The method according to claim 13, wherein said compound is added to a fermentation substrate in an amount of 0.0001 to 10 wt %.

23. A method for producing a fermented food, comprising fermenting a fermentation substrate by the method according to claim 13.

24. The method according to claim 23, wherein the fermentation substrate comprises milk or a milk-derived product, and the fermented food is a milk-fermented food.

25. The method according to claim 24, wherein the milk-fermented food is fermented milk.
